(19) United States
(12) Patent Application Publication
(10) Pub. No.: US 2002/0091574 A1
(43) Pub. Date: Jul. 11, 2002

(54) Master universal tariff system and method

(76) Inventors: Guy V. Lefebvre, Outremont (CA); Michel Lapointe, Ste-Catherine (CA)

Correspondence Address: David M. Mello, McDermott, Will & Emery, 28 State Street, Boston, MA, 02109, US

(21) Appl. No.: 09/952,134

(22) Filed: Sep. 12, 2001

Related U.S. Application Data
(60) Provisional application No. 60/207,788, filed on May 30, 2000.
(60) Provisional application No. 60/232,088, filed on Sep. 12, 2000.
(60) Provisional application No. 60/250,407, filed on Nov. 30, 2000.

(51) Int. Cl. G06F 17/60

(52) U.S. Cl. 705/19; 705/30

(57) ABSTRACT

The present invention is a system and method for providing real-time tariff and import data over a computer network, including, preferably, the calculation of total landed cost. The total landed cost is calculated as a function of input transaction information, such as transaction value, freight and insurance costs, type of good(s), import, shipment, and export countries. A duty calculation engine accesses relevant tariff rates and applies the lowest of such rates to arrive at a duty calculation. An import tax calculation engine accesses relevant databases of country specific import tax rates, charges and fees and applies them to arrive at import tax costs. A total landed cost calculation engine determines the total landed cost from the duty calculation and the import tax calculation.

### CROSS REFERENCE TO RELATED APPLICATIONS

This application claims the benefit of priority from commonly owned U.S. Provisional Patent Application Ser. No. 60/207,788, filed May 30, 2000, entitled SYSTEM FOR PROVIDING CONTINUOUSLY UPDATED REAL TIME GLOBAL CUSTOMS, TARIFF AND IMPORT DATA VIA A COMPUTER NETWORK; U.S. Provisional Patent Application Ser. No. 60/232,088, filed Sep. 12, 2000, entitled GLOBAL PRODUCT IDENTIFICATION SYSTEM FOR DETERMINATION OF TARIFFS; U.S. Provisional Patent Application Ser. No. 60/250,407, filed Nov. 30, 2000, entitled MASTER UNIVERSAL TARIFF SOFTWARE; and U.S. Provisional Patent Application Ser. No. 60/279,641, filed Mar. 29, 2001, entitled MASTER UNIVERSAL TARIFF SYSTEM AND METHOD, incorporated herein by reference.

### FIELD OF THE INVENTION

The present invention generally relates to systems and methods for providing tariff and import data. More specifically, the present invention relates to computer systems that determine and make such data available over a network.

### BACKGROUND OF THE INVENTION

Over the past several years there has been a simultaneous growth in international trade and global interaction and expansion of the World Wide Web (“the Web”). Increasingly, nations and regions are entering into trade agreements to facilitate increased international trade. World markets are becoming more interrelated and the demands for the importation of goods and services is growing accordingly. Part of the increased demand may also be attributed to the growth of the Web. The Web allows consumers, whether businesses, organizations, or private individuals, to shop the world on-line, from the convenience of a home or office computer.

Unfortunately, despite increased activity and demand, issues surrounding international transactions remain. That is, for each purchase of a product from another country, certain tariffs (or duty) and import taxes are usually applied to the transaction. Tariff rates and tax rates are country specific and change from time to time. Additionally, for each country, duty rates and tax rates tend to vary among types or categories of products, thus multiplying the complexity and volume of duty and tax information.

Keeping track of such a large volume of information can be a daunting and expensive undertaking for a seller (e.g., retailer or distributor). As a result, fulfillment of international orders emanating from customers located around the globe is attempted by only a small percentage of companies, due to the complexities of shipping across international borders. Of that small percentage that does attempt fulfillment of international orders, most usually only ship to a handful of countries.

To enable businesses, organizations, and individuals to more readily conduct international transactions, there is a need for a comprehensive system that provides updated tariff and tax information, as well as other transaction related costs and information. There is a further need for such a system to be a real-time system and for it to be accessible and functional over the Web, or other networks.

Currently, most trading countries worldwide utilize a tariff scheme that uses the Harmonized System (HS) codes. Defined by the World Customs Organization (WCO), the goal of the HS is to identify all possible products that can be traded throughout the world. A HS code can range from six digits to an unlimited number; typically, the code is less than 14 digits. The HS code defines the first 6 digits to provide a basic structure for all countries that adhere to the scheme, referred to herein as the “base HS code”. The structure enables countries to differentiate between products with various degrees of precision. However, if it is determined that the existing 6-digit HS code is not sufficiently precise, a country may add as many digits as required, as long as the guidelines provided by the HS are respected. Therefore, the HS provides a common base for identifying products, while letting countries customize the code to reflect specific needs through the allowance of code extensions.

Unfortunately, though the HS provides a flexible tariff scheme, using the 6-digit base HS code and nomenclature, the manner in which individual countries define HS code extensions creates difficulties. That is, national (i.e., country specific) tariff schedules can often build on the HS coding platform, non-standard, contradictory, and idiosyncratic breakouts or extension schemes. The non-standard breakouts are particularly problematic in the instance of a real-time transaction relying on real-time access of current and useful tariff information. To implement an accurate and efficient real-time data exchange system to facilitate international transactions, unique product codification is required. However, to codify all products in all trading countries would be an immensely time-consuming up front task, with equally onerous maintenance requirements. The sheer number of codes would enlarge a database to unacceptable proportions.

Complicating matters, the HS product codification can be very difficult to support and maintain. For example, when a new country is added to the system, the entire codification process must be performed for that new country. Additionally, if a country chooses to update its codes, then the product for which the HS code has been updated needs to be coded again (that is, for those updates that can be easily identified). Thus, it can be labor intensive and logistically impractical to keep such data current in anything close to real-time.

### SUMMARY OF THE INVENTION

The present invention is a system and method for providing real-time tariff and import data over a computer network, preferably including the calculation of total landed cost. A duty calculation engine accesses relevant tariff rates and applies the rate that is applicable to arrive at a duty calculation. An import tax calculation engine accesses relevant databases of country specific import tax rates, charges and fees and applies them to arrive at import tax costs. A total landed cost calculation engine calculates a total landed cost from the calculated duty (or tariff) and import tax, along with other transaction related costs, such as freight and insurance costs.

A real-time tariff and import data system in accordance with the present invention, may be implemented as a business-to-business (“B2B”) system, a business-to-consumer (“B2C”) system, or as some combination thereof. The system may be accessed over one or more of any of a variety of networks, such as local area networks (LANs), wide area networks (WANs), virtual private networks (VPNs), intranets, extranets, the World Wide Web (the “Web”), the Internet, telephone networks or some combination thereof.

The real-time tariff and import data system includes databases having current duty and tax rate information for a plurality of countries. These databases are coupled to a set of servers, for example, which host the duty calculation, tax calculation, and total landed cost calculation engines. The servers are accessible by any of a number of types of network enabled devices, such as personal computers (PCs), workstations, other (third party) servers or systems, personal digital assistants (PDAs), telephones, or other such devices. The data in the databases may be automatically updated by remote third party sources or they may be updated locally, or some combination thereof. Also, rather than representing each country in the system databases, the real-time tariff and import data system servers may link to third party sources of such tariff and tax information. The databases are kept substantially current, to provide accurate information to customers.

The content of the databases may embody trade restrictions imposed between countries. That is, where a country prohibits trade with another country, the real-time tariff and import data system may include a transaction validity checker that alerts the customer that the input transaction is forbidden by one of the countries (e.g., destination country) involved. For example, the United States prohibits the importation of cigars from Cuba. If a customer entered information for such a transaction, the real-time tariff and import data system may be configured to alert the customer to the trade restriction or may refuse to perform the requested calculations.

Users enter transaction inputs via an electronic device (e.g., PC, workstation, PDA, and/or other network enabled devices configured for user input). The inputs may include one or more of a PIN (if access is controlled), access code, origin country, shipment (or export) country, destination (or import) country, input code type, product code, transaction value, number of units being bought, unit code, cost of transportation, insurance cost, other (ancillary) costs, transaction currency, conversion currency, and output format code.

The access code input specifies whether the duties and taxes are calculated within or over a volume quota for a given product in a given country. The origin country is the country from where the product is considered to be manufactured. The shipment country is the country from where the products are sent. And, the destination country is the country to where the products are to be sent, also referred to as the country of importation. The input code type represents the type of input given for the product code (e.g., HS code or user defined product code). The product code identifies the category of the product. The unit code specifies the units (e.g., pounds, liters and so on) associated with the products, and the number of units tells how many units are being imported (e.g., 10,000). A desired output format from a predetermined set of output formats can be specified by the user through entry of an output format code. Output formats include duty rate, duty amount, detailed duty, tax rate, tax amounts, detailed taxes, duty and tax rates, duty and tax amounts, detailed duty and tax output, or total landed cost.

The inputs are entered into an on-line request form, which may be an XML (eXtensible Markup Language) document, for example. Preferably, the present invention includes a Web-based interface that allows users to interact with the system and get duty tariff and import data system servers to produce an output, in accordance with the chosen output format. As a Web accessible system, the real-time tariff and import data system is configured to provide real-time import duty, tax, and total landed cost information for shipments among the various countries represented in the databases.

In the present invention, the real-time tariff and import data system may be accessed by any of a variety of client device configurations, such as Web user client, a Java client 102B, and an XML client. Regardless of the configurations of the client device, communication between the client device and the real-time tariff and import data system is preferably accomplished using standard communication and format protocols and languages, such as the Internet Protocol and XML. Additionally, communication using encryption and access control mechanisms may be used.

In various embodiments, the present invention may include functionality or links to insurance providers for obtaining insurance cost figures and/or to transportation providers for obtaining transportation figures. Additionally, the present invention may also facilitate or enable the purchasing of such insurance and transportation. In such embodiments, the user need not input insurance or transportation cost information, as the case may be, and the outputs may variously include the system calculated insurance and transportation costs.

The real-time tariff and import data system may provide for customer account and billing, based on use, transactions, or flat fee structures. The system may serve as a back-end system for a third party, or as a front end system that is directly accessible by customers.

A MASTER UNIVERSAL TARIFF™ (MUT™) system and method may be included as a part of the real-time tariff and import data system or as a standalone system that may or may not be configured to interface with the real-time tariff and import data system. “MASTER UNIVERSAL TARIFF” and “MUT” are trademarks of Tariffic, Inc. of Montreal, Canada. The MUT™ system simplifies the task of classifying products and mitigates potential complications arising from variously defined HS code extensions among various countries. That is, the MUT™ system provides a manner of defining products at a global level to maximize compatibility of HS-based codes across countries and to avoid errors in the coding of products for international transactions. The existing HS scheme is preserved and, to the maximum extent possible, for each product a single, unique global MUT™ code is defined that is compatible with the country specific local MUT™ code of all trading countries. A user, such as a retailer, manufacturer, or distributor, can create a database of its product offerings that comply with the global MUT™ codes, by entering and classifying its products using the MUT™ system.

The global MUT™ codes and country specific local MUT™ codes may be formed as described below. Each global MUT™ code includes the base HS code plus MUT™ system extensions. The particular extensions used by the MUT™ system are determined as a function of an evaluation of the HS code extensions defined by substantially all countries that use the HS for each product. Generally, the following steps are implemented to define MUT™ codes:

1. Analyze and extract all of the product differentiation (by category and value) currently being defined in product code extensions by each country for each of its trading products.

2. Consolidate all the categories and values, defined by every country for every product having the same base HS code.

3. Codify a global MUT™ code format for every base HS code and generate corresponding, local MUT™ codes for each country according to the categories consolidated in the previous step.

4. Validate the MUT™ code based on the codification performed in the previous step.

To establish a set of MUT™ codes that uniquely and precisely facilitate classification of Air substantially all products in every country, the local product codes of each country are obtained and analysis is performed to extract all product differentiation embodied in the extensions to the base HS product codes. Differentiation is accomplished within extensions by category and value. A category is a product attribute (e.g., color) defined, for example, by a digit pair (e.g., digits 7 and 8). There may be several values for each category (e.g., red, green, and blue). A value is represented in the digit pair numerically (e.g., a country may have defined values for digit pair 7 and 8 of “00”, “10”, “20” and “30”). For each product of a given country having the same base HS code, product codes (i.e., HS base code+extensions) are obtained. Each country may have defined different categories and values for each product of a certain base HS code, yielding a plurality of country defined product codes having different extensions (i.e., the same or different categories with the same or different values). After several countries have been extracted, virtually all product distinctions have been identified and covered; that is all categories and values have typically been determined.

Category codification is performed over several steps. That is, all categories and values defined by every country for every product are analyzed and, to the maximum extent possible, they are consolidated. The previously extracted categories are grouped (or unified) and redundancies are eliminated. The possible values for each category are consolidated, to ensure that each value for a given category is mutually exclusive and unique. A numerical value is assigned to every value in the category, so two values for the same category do not have the same definition. A “special” value is also created for each category; the special value is “not applicable”, which may be coded as “00”. The value “90” is also defined as “other”, to encompass values for which there is no specific 2-digit representation.

In other embodiments, to account for large numbers of categories, rather using 2-digit category representation, 3-digit representations may be used. Therefore, the value “10” previously described would be represented as “010”. The “90” would be represented as “900”. In this embodiment, every value between 900 to 999 may be reserved for internal use, so could not be used to describe a specific value in a category. Reserving such codes, allows flexibility to accommodate later changes and improvements to the MUT™ system. Appendix J describes the preferred manner for implementing a 3-digit code and Appendix B describes a manner of validating such codes

MUT™ codification is then performed, wherein a global MUT™ code format is created for each HS code. A global MUT™ code format for a given HS code includes the base HS code plus an extension comprised of a different digit pair designated for each consolidated category, thereby creating a set of global MUT™ codes with global applicability.

Adhering to the global MUT™ code format, a set of global MUT™ codes is defined for each base HS code. Each global MUT™ code in the set of global MUT™ codes includes the base HS code plus different valid combinations of categories and values. Values for each category of a global MUT™ code are defined to include all values used by each country for that category, to the maximum extent possible.

For each country and for each base HS code a table of local MUT™ codes is defined. Each local MUT™ code in the table of local MUT™ codes adheres to the format of the global MUT™ code, so includes the base HS code plus different valid combinations of category values, but only for the categories applicable for that country. If a country does not use a category in the global MUT™ code format, the values of the category in the table of local MUT™ codes for that all country are “not applicable”. This process is accomplished for each HS code and for each country, so that for each base HS code, a table of local MUT™ codes with applicable categories and values exists for each country that uses the HS. These tables may be combined into a single table, for each base HS code.

Each global MUT™ code is validated against the local MUT™ codes of each country having the same base HS code. One part of a preferred outcome of MUT™ validation is a “Country Code Table” for each country comprised of a listing of all valid local MUT™ codes for that country. Another part of the preferred outcome is a “Master MUT™ Table” comprised of all validated global MUT™ codes. These tables, which may be stored in a MUT™ database system, are made available to users for product coding and to otherwise facilitate international transactions.

A valid global MUT™ code is one for which each and every country has at least one local MUT™ code having category values that do not conflict with the category values of the global MUT™ code being validated. If there is more than one local MUT™ code that is valid for the global MUT™ code, a best local MUT™ code is determined. For a given country, a best local MUT™ code is determined as function of the highest correlation among category values between the global MUT™ code and the valid local MUT™ codes. Each global MUT™ code that is validated is included in the Master MUT™ Table. Each local MUT™ code for which there is a valid global MUT™ code is included in the Country Code Table for the corresponding country. An association is created between each global MUT™ code and its related local MUT™ codes. If a global MUT™ code can not be validated against one and only one local MUT™ code for each and every country, an error message results if an attempt is made to validate that global MUT™ code. Appendix K provides information describing validation using 3-digit representations, instead of 2-digit representations.

When a new country begins to use the HS, it may adopt the global MUT™ codes for its products, or the country may at least define its product codes to be consistent with the global MUT™ codes. In any case, when the new country's HS based product codes are added to the MUT™ system, the MUT™ system is used to generate local MUT™ codes for that country and to add that country's local MUT™ codes to the Country Code Tables, as appropriate. If a new category and/or value results, the Master MUT™ Table and Country Code Tables may be updated accordingly.

As will be appreciated by those skilled in the art, the MUT™ system facilitates product classification in a globally compatible manner and, thus, substantially reduces the potential product code database size, by forming consolidated global MUT™ codes, rather than maintaining exhaustive databases of country specific codes. Since global MUT™ codes arc built on HS codes, the base HS code (and extensions) can easily be obtained for any country in the MUT™ system. The addition of new countries or the update of existing products is made easy.

With the Master MUT™ Table and Country Code Tables created, a user (such as a manufacturer or distributor) may enter and classify its product offerings using the MUT™ system. To facilitate such entry and classification, the MUT™ system may include a user interface, such as a Web browser interface, or the MUT™ system may be implemented as a backend system with a link to an e-commerce system having a user interface or as subsystem to the real-time tariff and import data system. For each of such users a database of products conforming to the global MUT™ codes from the Master MUT™ Table may be defined and maintained (including editing and deleting classified products). Entering a product may be accomplished by identifying the product by “SKU”, as known in the art, and by product name. Classification of the entered product involves associating the user's entered product with a base HS code and defining product code extensions according to the global MUT™ codes of the Master MUT™ Table. Once the product is entered and classified it may be saved and maintained in the user's database of products, which may be stored local to the MUT™ system or at the user's e-commerce Web site, as examples.

The MUT™ system user interface may provide various mechanisms to perform classification. The mechanisms may include one or more of a search by keyword, an interactive search, a search by HS code, and/or a search by local HS code. The search by keyword mechanism allows the user to search for one or more keywords or search terms that, for example, may be found in a description of an HS code. For example, the user may enter one or more keywords and select a search type (e.g., a boolean search) and have a list of selectable products presented that include the search terms. Base HS codes are associated with the search results.

An interactive search lets the user define or select a set of parameters (e.g., section, chapter, heading, and/or subheading), preferably from a group predefined parameters, related to an HS code or product and have returned a base HS code. The next mechanism, i.e., the search by HS code mechanism, allows the user to enter the base HS code, which is typically 6 digits, and obtain a list of products that include the base HS code. With the base HS code provided to the user, the user defines category values, on a category by category basis, as allowed by the corresponding global MUT™ code for the given base HS code. As a result, the user's MUT™ product code is defined and may be saved in the user's product database. Another mechanism, i.e., the local HS code search mechanism, allows the user to enter a valid local HS code for the product, if known, and proceed to define extensions according to the corresponding global MUT™ code. Once the extensions are defined, the user's MUT™ product code may be saved into the user's product database.

The user may retrieve its existing MUT™ product codes from its product databases for editing, again on a category by category basis. Through these various mechanisms of entering, classifying, and saving product codes, links are formed between each MUT™ product code from the user's product database and the corresponding global MUT™ code from the Master MUT™ Table, for each of the user's products. Accordingly, through the Master MUT™ Table associations between the MUT™ product codes of various countries and users are formed.

A new or edited product code may be tested or verified by linking to the real-time tariff and import data system, wherein a total landed cost may be calculated for the new or edited product. With the product identified and a country of origin, country of shipment, and country of destination, and the transaction currency and result currency defined, a total landed cost may be calculated using the MUT™ product code. A user may “share” its MUT™ product codes with its affiliates, partners, distributors, and so on, by providing such entities access or links to certain one or more of its MUT™ product codes.

The real-time tariff and import data system, including the MUT™ system, may be configured for access via one or more of a variety of types of networks, as previously described and the user interface necessary to enter and classify products may be provided on any of the previously mentioned devices.

### BRIEF DESCRIPTION OF THE DRAWINGS

The foregoing and other objects of this invention, the various features thereof, as well as the invention itself, may be more fully understood from the following description, when read together with the accompanying drawings, described:

FIG. 1 is a representative architecture of the real-time tariff and import data system, in accordance with the present invention;

FIG. 2 is an architecture of a distributed real-time tariff and import data system, in accordance with the present invention;

FIG. 3 is a software architecture for the real-time tariff and import data system of FIG. 1 or FIG. 2;

FIG. 4 is a block diagram showing the primary functional components of the software architecture of FIG. 3;

FIG. 5 is a diagram depicting a standard Web browser-based approach to client-server exchange with the real-time tariff and import data system of FIG. 1 and FIG. 2;

FIG. 6 is a diagram depicting an approach to client-server exchange with the real-time tariff and import data system of FIG. 1 and FIG. 2;

FIGS. 7A, 7B and 7C are diagrams depicting XML request string exchange and processing by the real-time tariff and import data system of FIG. 1 and FIG. 2;

FIGS. 8A, 8B and 8C are diagrams depicting Web-based request exchange and processing by the real-time tariff and import data system of FIG. 1 and FIG. 2;

FIG. 9A and 9B are diagrams depicting Java-based request exchange and processing by the real-time tariff and import data system of FIG. 1 and FIG. 2;

FIG. 10 is a flowchart depicting a process for validating MUT™ codes;

FIG. 11 is a diagram of a representative MUT™ architecture;

FIG. 12 is an overview of a representative MUT™ system screen topology; and

FIG. 13A through FIG. 13K are diagrams depicting representative MUT™ system screens.

For the most part, and as will be apparent when referring to the figures, when an item is used unchanged in more than one figure, it is identified by the same alphanumeric reference indicator in all figures.

### DETAILED DESCRIPTION OF THE PREFERRED EMBODIMENT

The present invention is a system and method for providing real-time tariff and import data over a computer network, including the calculation of total landed cost. In the preferred form, a duty calculation engine accesses relevant tariff rates and applies the rate that is applicable to arrive at a duty calculation. An import tax calculation engine accesses relevant databases of country specific import tax rates, charges and fees and applies them to arrive at import tax costs. A total landed cost calculation engine determines the total landed cost from the duty calculation and the import tax calculation, along with other transaction related costs, such as transaction value, freight and insurance costs, type of good(s), import, shipment, and export countries.

A real-time tariff and import data system in accordance with the present invention, may be implemented as a business-to-business (“B2B”) system, a business-to-consumer (B2C) system, or as some combination thereof. The system may be accessed over one or more of any of a variety of networks, such as local area networks (LANs), wide area networks (WANs), virtual private networks (VPNs), intranets, extranets, the World Wide Web (the “Web”), the Internet, telephone network, or some combination thereof. The real-time tariff and import data system may serve as a front-end system, directly accessible by those seeking tariff, import tax and/or total landed cost data for a transaction. In other embodiments, the real-time tariff and import data system may serve as a back-end system, coupled to a front-end international transaction system, for example.

Part I—Hardware and Software Architecture

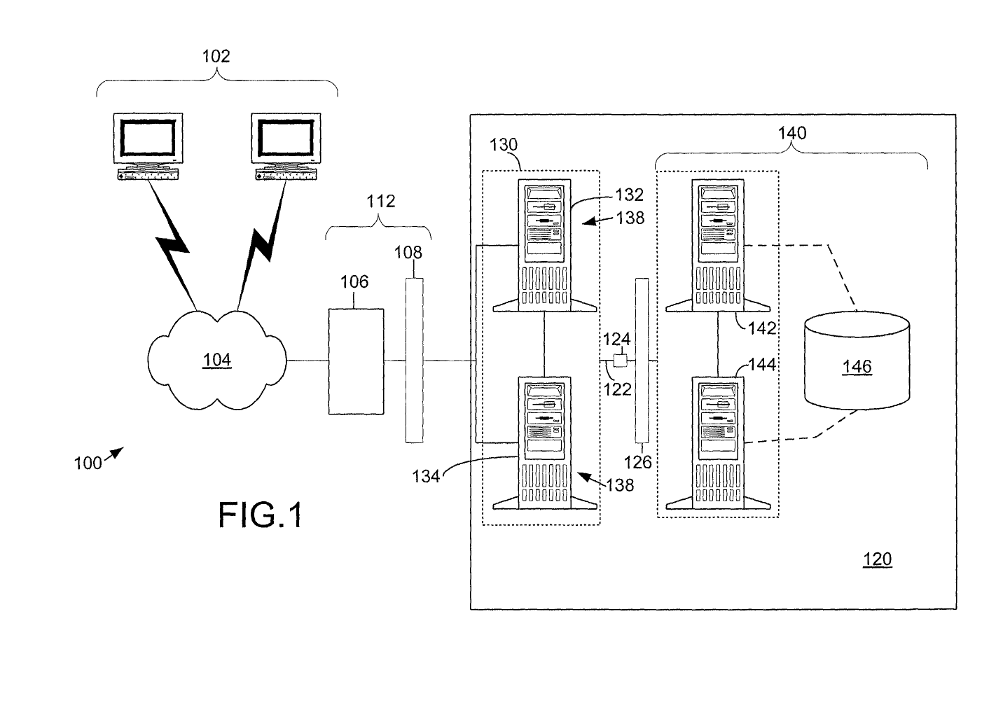

FIG. 1 shows a representative architecture 100 implementing the present invention. Architecture 100 includes a set of client devices 102 configured to access the real-time tariff and import data system 120 via the Internet 104. Access to the real-time tariff and import data system may be provided via a standard router 106 and firewall 108.

In accordance with the preferred embodiment, the real-time tariff and import data system 120 makes information accessible regarding tariffs in approximately 225 countries for approximately 5,800 products listed in the Harmonized Coding System (HCS), which are represented as established country-based product Harmonized System (HS) codes. Along with information on various customs duties, applicable tax rate information is provided for a plurality of products, and vital information necessary or useful for doing business in various countries. Such information is stored and managed by a database management system 140.

Preferably, the real-time tariff and import data system 121 includes the following characteristics:

(1) High Level of Availability: To simultaneously accommodate the needs of clients around the globe, the system is preferably accessible for substantially 24 hours a day, 7 days a week, for a total availability rate of approximately 99%, or more. To accomplish such high availability, the system architecture accommodates a minimal mean-time-to-recovery (i.e., not more than a few seconds), which may be accomplished, at least in part, with customary redundancy, “hot spares”, and fail-over mechanisms. As examples, for a 99% availability rate, the system can not be down for more than 88 hours per year (i.e., up for 8,672), and for an availability rate of 100% the system is down for 0 hours per year (i.e., up for 8,760).

(2) High Level of Transparency of System Faults: Owing to the recovery mentioned above, client-users are substantially unable to detect that a system fault has occurred. In a worst-case scenario, response time of the system is only prolonged by a few seconds, rather than producing error messages or terminating jobs.

(3) Ability to Cope with a High Volume of Transactions: User traffic is an important factor to take into consideration with regard to bandwidth use. Indeed, the width of the bandwidth is an important element in the system response time. The following table, Table 1, presents the number of concurrent users that can be supported, depending on the kind of bandwidth used (calculated for a connection lasting in the order of 15 seconds):

TABLE 1
Concurrent Users

| Connection | | Concurrent | |
|---|---|---|---|
| type | Maximum bandwidth* | users* | Hits per day* |
| Dedicated | Modem Speed | 6 | 46,258,560 |
| PPP/SLIP | | | |
| 56K (Frame | 56,000 bps | 9 | 70,383,909 |
| Relay) | | | |
| ISDN (using | 56,000-64,000 bps | 19 | 157,988,571 |
| PPP) | | | |
| T1 | 1,540,000 bps | 210 | 1,851,428,571 |
| Fractional | Varies as needed | Varies | Varies |
| T1 | | | |
| T3 | 45,000,000 bps | 6,277 | 55,525,083,429 |
| OC3 | 150,000,000,000 bps | 20,927 | 185,142,857,143 |

*These values are estimates and may vary, but they are useful as guidelines in choosing connection types.

(4) Tamper-Proof Data and Transaction Security: Use of a variety of security mechanisms, discussed in detail below, provide for control of access to data and protection of is databases against attacks via the Internet, and ensures the confidentiality of clients' transactions.

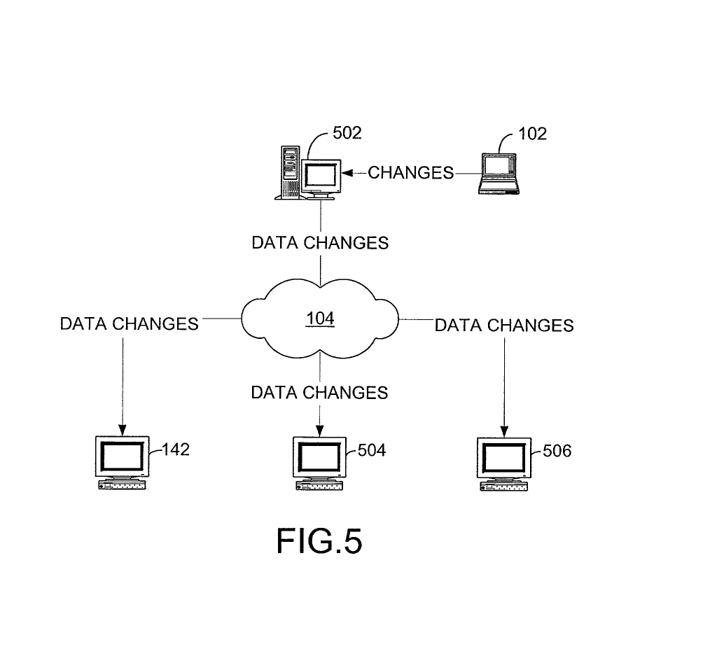

(5) Accuracy of the information contained in databases 146: Customs information varies from country to country. Additionally, countries often pass new laws that change tariffs from one year to the next, or even in the course of the same year. The real-time tariff and import data system 120 allows for the expedient integration of these changes, by accommodating automated information distribution and database updates. Database updates may be accomplished locally, remotely (possibly via third party systems), or some combinations thereof, as discussed in more detail with respect to FIG. 5.

The hardware architecture shown in FIG. 1 embodies the characteristics outlined above. The real-time tariff and import data system architecture 120 includes a cluster of front end application servers 130, as a first logic or application layer, coupled to a back end database management system 140, as a data layer. In the architecture of FIG. 1, the application servers 132 and 134 are accessible via the Internet through a local network 112, which includes router 106 and firewall 108. Firewall 108 protects servers 132 and 134 from Internet attacks by filtering and controlling access to the servers, which is discussed in more detail below.

Generally, one of the major factors in the reliability of a Web site is the reliability of the servers used to host the Web site. Each of application servers 132 and 134 serve as intelligent relief systems to the other; they “know” (i.e., monitor) each other's status, which aids in the processes of load balancing and fault recovery.

While FIG. 1 shows the application layer to include two application servers, a greater number of servers may be used and they may be located at geographically local or remote locations, or some combination thereof. The architecture of FIG. 1 offers scalability, in that more servers may be easily added. In the preferred embodiment, an increased number of servers allows increased availability. Additionally, the processing load of the various application object components that are to be executed at a given time on the servers is dynamically balanced among the clustered application servers 130. In the preferred embodiment, the applications running on servers 132 and 134 are written in object oriented code.

Both application servers, 132 and 134, are configured to respond to client requests, so that they can easily share the load. A load-balancing module distributes requests between servers 132 and 134, such modules are known in the art and not discussed in detail herein. If one server (e.g., server 132) is no longer responding, all requests must then be directed towards the other server (e.g., server 134), or other servers if there are more than two application servers. The load-balancing module is replicated on both (or all) application servers, which allows the application servers to ensure continuous request distribution, regardless of which server(s) go down. To ensure system fault tolerance, status information is also replicated on each application server. Thus, even minor faults can be hidden from users, leaving application processing substantially unaffected.

In FIG. 1, the application layer clustered servers 130 are coupled to the data layer 140 via a local network 122 that includes a switch 124 and firewall 126. The database management system 140, or data layer, includes the data servers 142 and 144 and the databases 146 that include all of the tariff and other import data. In the preferred form, database 146 includes a set of shared RAID (Redundant Array of Inexpensive Disks) external disks. RAID systems are known in the art and not discussed in detail herein. In the preferred form, the data layer servers 142 and 144 of FIG. 1 are Microsoft SQL servers, clustered using standard clustering technology (e.g., such as that provided by Microsoft Corporation of Redmond Wash.).

The architecture of the data layer 140 is designed to provide maximum data availability. That is, if one server (e.g. server 142) breaks down, the other server (e.g., server 144) takes over in a manner that maintains transparency to users. Therefore, transactions that are taking place during a database management system 140 fault will not be interrupted, since the requests sent to the faulty server will be automatically transferred to the active server. Since both data layer servers 142 and 144 are connected to RAID external disks 146, disk faults can be dealt with one disk at a time, without halting tasks. Using background monitoring, a problem with one disk can be detected before a fault occurs so that the damaged disk can be replaced before service is interrupted.

Both servers 142 and 144 share a “heartbeat” connection, are part of a local network, are linked to the Internet, and require the use of dual Ethernet network interface cards, in the preferred embodiment of FIG. 1. In this configuration, the database servers 142 and 144 have public IP addresses in order to facilitate data updating operations, but this can expose the servers 142 and 144 to attacks from the Internet. To protect against such attacks, firewall 126 is used to filter requests to the database servers 142 and 144. Thus, only the logical layer servers 132 and 134, i.e., the servers used for updating data (replication), will be able to access the database servers 142 and 144, and server 132 and 134 are also protected by firewall 108.

The databases 146 of database management system 140 includes the following information or databases:

(1) Customs tariff and taxes databases,

(2) Customs information databases on various countries, and

(3) System client databases (where the system maintains client-user accounts).

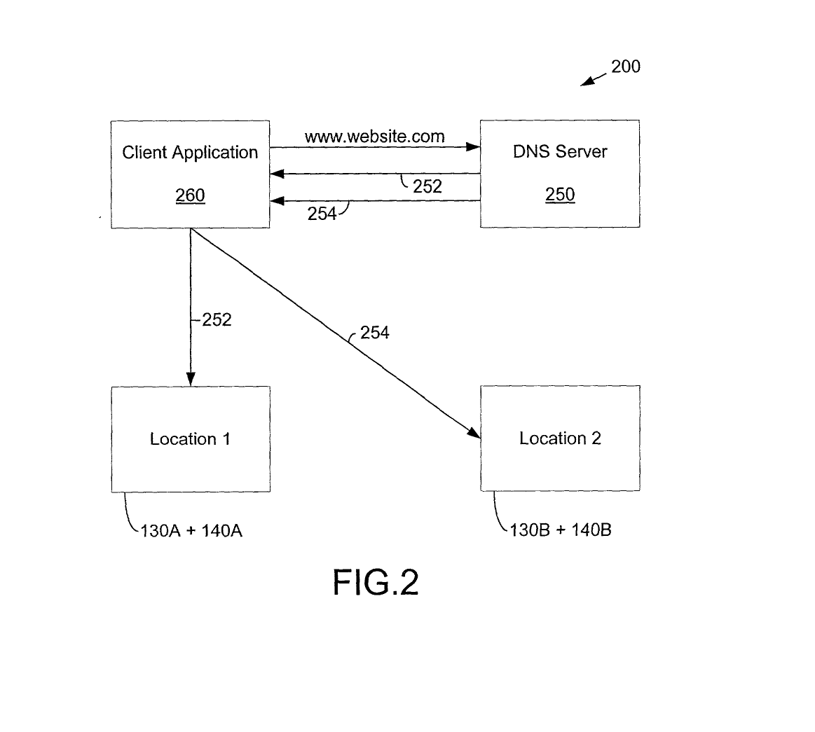

As previously mentioned, real-time tariff and import data system 120 may include multiple application servers in different locations to provide a more robust fail-over solution, in case of major disaster at one site, as is shown in FIG. 2. As previously mentioned, the real-time tariff and import data system 120 is preferably a Web-accessible system. Therefore, a request may be submitted to a Domain Name Server (DNS) 250 which then returns up to two specific IP addresses. Since the real-time tariff and import data system 120 has multiple servers in different locations, in this embodiment, the DNS server 250 returns the optimal address 252 and the second best address 254. The optimal address 252 can be defined as the one with the lowest latency and with an acceptable load.

To provide a fail-over solution and to provide high availability, the client application 260 must react when the response is not sent back after an acceptable timeout. It is preferred that after an acceptable timeout expires, the request is resent a certain number of times to the DNS server 250. To use this feature, a toolkit or client application 260 is configured support the following:

(1) multiple IP addresses in response to it's address resolution request, and

(2) the ability to try to connect using the second IP address, if the first IP address attempt is unsuccessful.

Preferably, the DNS server 250 always returns up to two IP addresses, so if the optimal 20 application server 130A (with DB management system 140A) is down, the client application 260 (or device) redirects the request to the second best application server 130B (with DB management system 140B), after an acceptable timeout as been expired. However, if the client application 260 or toolkit does not support this feature, only the optimal IP address will be available to the client application 260. To have a full fail-over proof client application 260, the timeout is preferably set to be about 10 seconds. Also, when the timeout expires, the client application 260 is configured to re-send the request, alternating from the optimal server 130A to the second best server 130B.

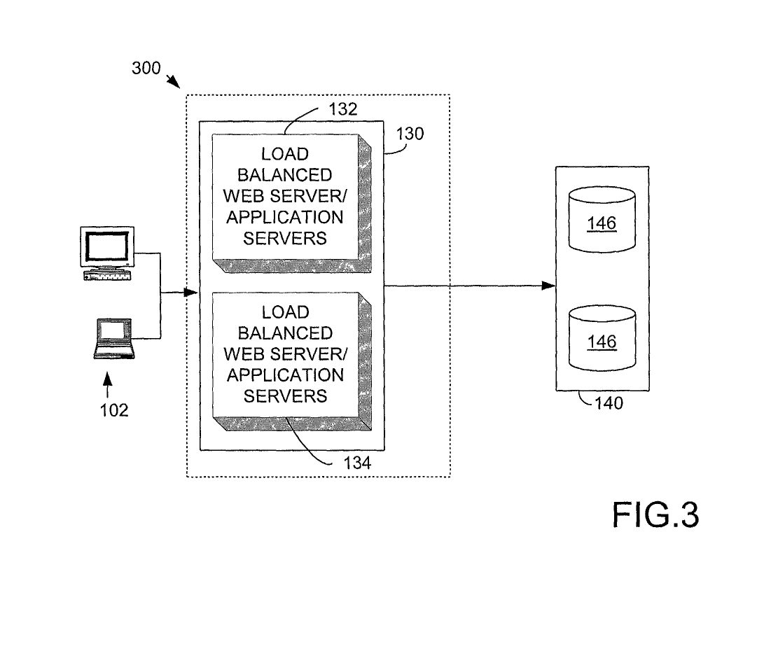

The preferred embodiment of a software architecture 300 of the real-time tariff and import data system 120 is shown in FIG. 3, which serves as the system's logical structure. This logical structure allows for optimal use of resources from different servers. The application servers 132 and 134 support transparent replication, load balancing and fail-over for both the dynamic generation of Web pages (i.e., at the presentation layer) and components (i.e., at the logical layer components).

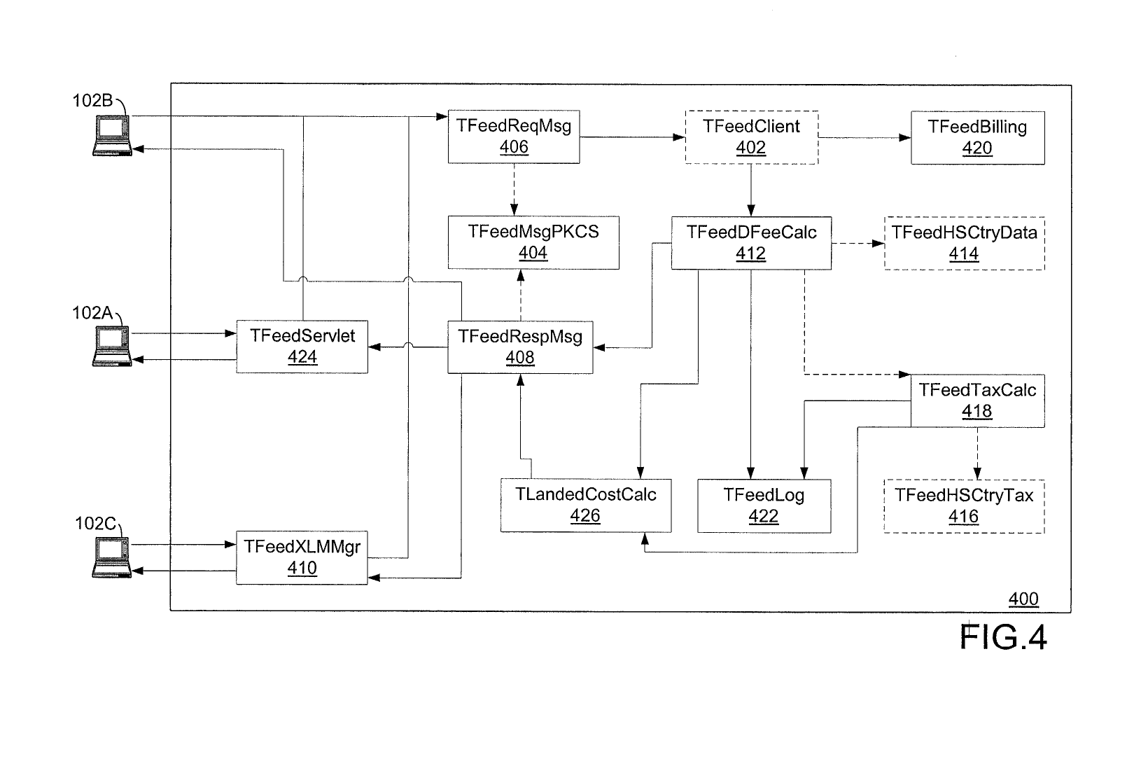

The real-time tariff and import data system 120 main application object components 400 are shown in FIG. 4 and described below.

(1) A TFeedClient object component 402 includes all relevant information for customers (e.g., corporate customers) known to the system and provides methods for accessing specific customer information, which may be stored in customer accounts.

(2) TFeedMsgPKCS object component 404 is configured to customize security levels to client specifications. Data exchanges may be conducted in encrypted or plain-text format. For encrypted transactions, this object component 404 can encrypt and decrypt messages, however, this function requires that public and private access keys be installed in both the customer's system (or client device) and on the application servers 130.

(3) TFeedReqMsg object component 406 prepares received client requests for the other system components. Requests may use the HTTP protocol, may be made directly from the components Java installed in the customer's system or may use an XML format, as described in greater detail below. The TFeedReqMsg object component may be instantiated using any one of these sources.

(4) TFeedRespMsg object component 408 prepares a response to a client request and transmits the response to the client (via TFeed-Servlet, if needed). Responses are directly delivered using HTTP protocol or using an XML format from the TFeedRespMsg object component 406, as described in further detail below with respect to the data exchange process.

(5) TFeedXMLMgr object component 410 manages the exchange of information between the real-time tariff and import data system 120 Web site and clients using an XML format.

(6) TFeedDFeeCalc object component 412 calculates duty fees (i.e., customs charges). This component is also referred to as the duty calculation engine.

(7) TFeedHSCtryData object component 414 provides the tariff for a country and for a specific corresponding HS code. This object component is used by TFeedDFeeCalc 412 to perform customs charges calculations.

(8) TFeedHSCtryTax object component 416 provides the tax rate for a country and for a specific HS code. This object component is used by TFeedTaxCalc 418 below.

(9) TFeedTaxCalc object component 418 applies the tax rate for a product, according to the HS code provided and the country of import, to determine the tax charges This component is also referred to as the import tax calculation engine.

(10) TFeedBilling object component 420 manages the customer account billing process.

(11) TFeedLog object component 422 keeps a running log of all client requests fed into the database. This information may be used as a reference for operating difficulties reported by clients or for cases in which a customer wishes to contest a bill.

(12) TFeedServlet object component 424 manages incoming requests sent via a Web browser and outgoing responses, using HTTP protocol.

(13) TFeedTTLCalc object component 426 calculates the total landed cost for a transaction, using the calculated duty from the duty calculation engine 412 and the import tax calculation engine 418, along with other transaction date (e.g., insurance and transportation costs).

The content of the databases may embody trade restrictions imposed between countries. That is, where a country prohibits trade with another country, the real-time tariff and import data system may include a transaction validity checker (e.g., a TFeedValidTrans component, not shown) that alerts the customer that the input transaction is forbidden by one of the countries (e.g., destination country) involved. For example, the United States prohibits the importation of cigars from Cuba. If a customer entered information for such a transaction, the real-time tariff and import data system may be configured to alert the customer to the trade restriction or may refuse to perform the requested calculations.

In various embodiments, the present invention may include functionality or links to insurance providers for obtaining insurance cost figures and/or to transportation providers for providing transportation figures. Additionally, the present invention may also facilitate or enable the purchasing of such insurance and transportation. In such embodiments, the user need not input insurance or transportation cost information, as the case may be, and the outputs may variously include the system calculated insurance and transportation costs.

Returning to the database management system 140 of FIG. 1, a variety of operations are involved in maintaining data integrity, as discussed below. Database security requires that customer (or user) security measures be established. Therefore, security audits may be conducted on a regular basis to verify access to the database and authentication may be required for access to database 146. SQL Server offers two authentication modes:

(1) Windows NT Authentication Mode: SQL Server can use Windows NT to authenticate users. User accounts are managed and defined in Windows NT and the access rights (and roles) are defined on the SQL Server.

(2) Mixed Mode: Previous modes can be used along with the authentication mode above, which requires that an account be created, with username and password, on the SQL Server. This account is saved in the system tables of the SQL Server.

In the preferred embodiment, the mixed mode is used, since it requires no control over the network and its clients (e.g., NT accounts and client network management). However, users who have different roles may also be defined on the SQL Server. By “role” it is meant that a group of users is treated as a single unit, to which access permissions can be applied. The access permission attributed and/or deleted for one role is applied to all of the users who share that role. The following table, Table 2, shows a list of predefined roles on the SQL Server. New roles may be defined to control access to the tables and/or procedures of any database.

TABLE 2
Predefined Roles

| Fixed database role | Description |
|---|---|
| db_owner | Carries out all of the maintenance and |
| | configuration operations in the database. |
| db_accessadmin | Adds or deletes access rights for Windows NT |
| | users and groups and SQL server accounts. |
| db_datareader | Reads all of the data from all of the tables. |
| db_datawriter | Adds, deletes or modifies the data in all of the |
| | user tables. |
| db_ddladmin | Executes all data definition commands in the |
| | database (i.e., in the Data Definition Library |
| | (DDL)). |
| db_securityadmin | Changes role attribution and manages access |
| | permission. |
| db_backupoperator | Database backup |
| db_denydatareader | Denies access to functions for reading data in |
| | any of the user tables. |
| db_denydatawriter | Denies access to functions for adding, |
| | changing or deleting data in any one of the user |
| | views or tables. |

SQL Server also has a powerful “Profiler” that records and analyzes all of the operations executed by the SQL Server (i.e., database management servers 142 and 144). The resulting reports can be saved in a text file or in an SQL Server table. Audits regarding access to the servers 142 and 144 may therefore be conducted by recording the following information: access granted; access denied; procedures used; sessions established; and user accounts used. All of this information provides an excellent support tool in establishing who has done what and when.

To protect the databases 146, backup operations are preferably conducted. Generally, there are three methods for performing data backups:

(1) Offline (Cold) Backup: Database services are halted; backup operations are then carried out and the database is put back on line. During this time, the database is not available.

(2) Online (Hot) Backup: Database services are active, the database remains on line, but no access is granted during this operation.

(3) Active Online Backup: The database is active and is accessible by the applications. In the preferred embodiment, option 3 above is used, since it allows backup during normal operations without interruption. This option also allows around-the-clock access. Although this operation minimally increases the server load, it is still advisable to carry out these operations during the hours when the load is at its most stable.

Since there is such a heavy reliance on the database content for producing accurate cost figures, a significant challenge is to guarantee that the information contained in the databases is accurate. One way to ensure the accuracy of data is to perform database updates using the functions of the SQL Server. For example, data replication provides a fast and effective way of distributing information and reducing dependency on a central database server. SQL Server allows users to replicate data from one SQL Server to another SQL Server, or to several other types of databases by different makers (e.g., Oracle, Sybase or IBM DB2). The SQL Server replication function is based on the “publish and subscribe” model in which one database information server plays the role of a “publisher” while the others play the role of “subscribers”, as is shown in FIG. 5. A publisher is the database system or server that makes data available for replication, and may be the “owner” or source of the data. In FIG. 5, database changes may be sent from a client device 102, for example, to a publisher database system 502. Publisher 502 maintains a list of publications (i.e., data for distribution) and subscribers for the publications. A subscriber may be a database server (e.g., servers 142 and 144) that receives and updates (or replicates) its own database data with the updated publication. Subscriber 1 504 and Subscriber 2 506 may be systems, clients, or servers which are not directly a part of the real-time tariff and import data system 120.

Generally, there are two types of subscriptions:

(1) The “pull” subscription, in which the subscriber (e.g., 142, 504, or 506) requests regular updates from publisher 502.

(2) The “push” subscription, in which publisher 502 distributes the changes to various subscribers (e.g., 142, 504 and 506) when changes occur or according to a predefined plan.

Database management system 140 supports at least three types of replication between a publisher and subscribers:

(1) Snapshot Replication: As its name indicates, this type of replication takes a photo or a snapshot of the data to be published at a given moment in time. These snapshots can be taken according to a plan or upon request. Snapshot replication uses very few system resources. However, all of the subscriber data is refreshed. All information is transferred to the subscribers, which requires a high-performance bandwidth for high volumes of data.

(2) Transactional Replication: In this type of replication the changes made at the publisher level are distributed on a continuous basis or at established intervals to one or several subscribers. This type of replication is most appropriate for cases in which only one publisher is available and updates are done on this publisher. Thus, subscribers could upload changes and update their data at a predetermined time.

(3) Merge Replication: This type of replications allows publisher 502 and subscriber 142, 504 and 506 to operate independently of each other and to periodically reconnect to update or consolidate their respective data.

In the case of the real-time tariff and import data system 120 Web site, transactional replication is preferred. Updates on customs data are carried out on a server that plays the role of a publisher and all changes are distributed to subscribers.

The following steps allow implementation of replication functionality on a server that will play the role of a publisher:

(1) Installation of one version of the database;

(2) Definition of publications and articles (including table sets, information to be replicated);

(3) Configuration of publication mode (for transactional replication);

(4) Definition of a publication frequency (for data transfer to subscribers);

(5) Definition of subscribers (e.g., database servers and in client database servers); and

(6) Configuration of different firewalls or proxies for replication via the Internet.

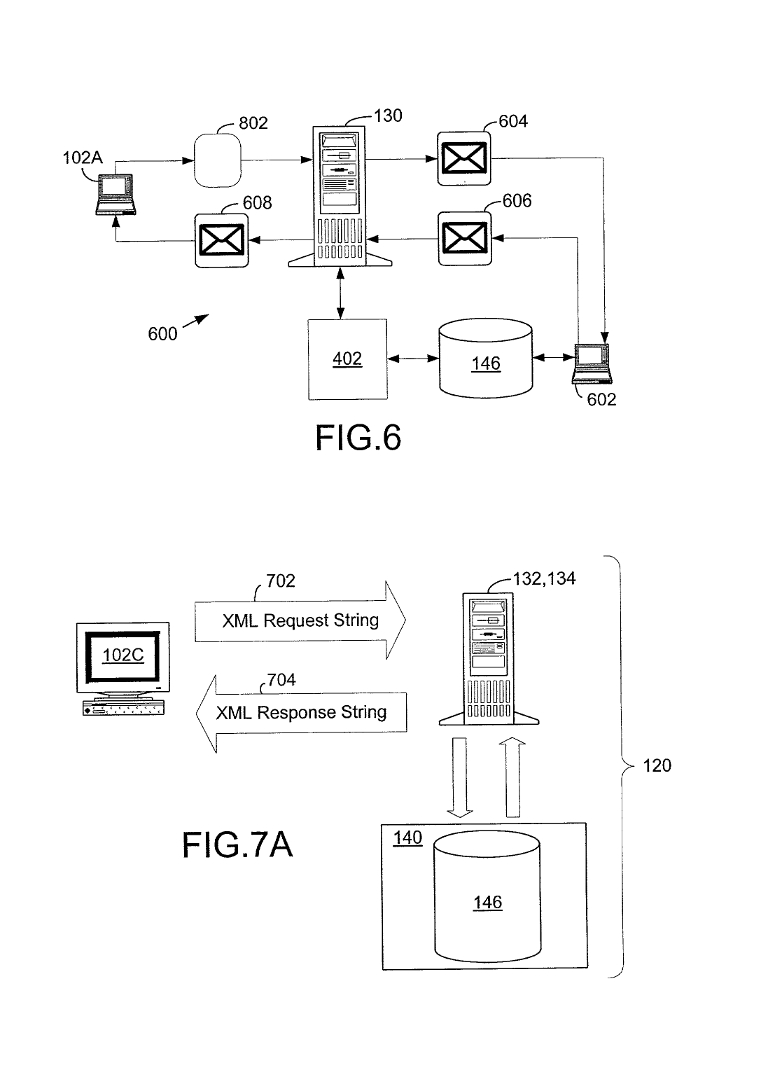

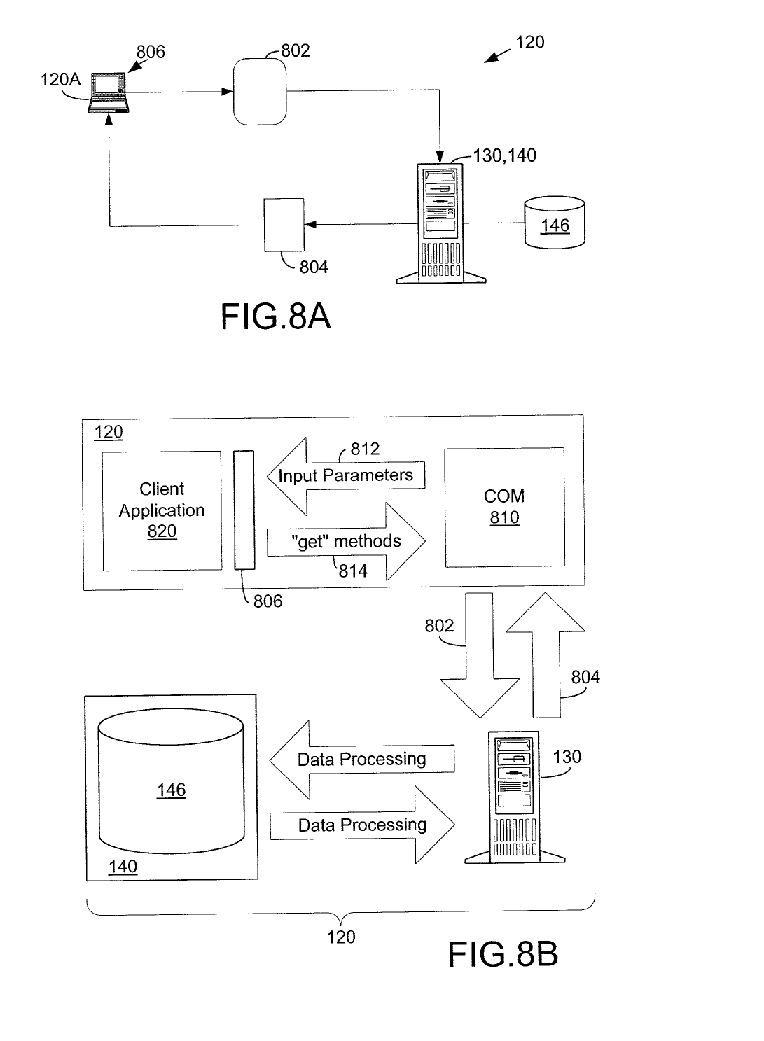

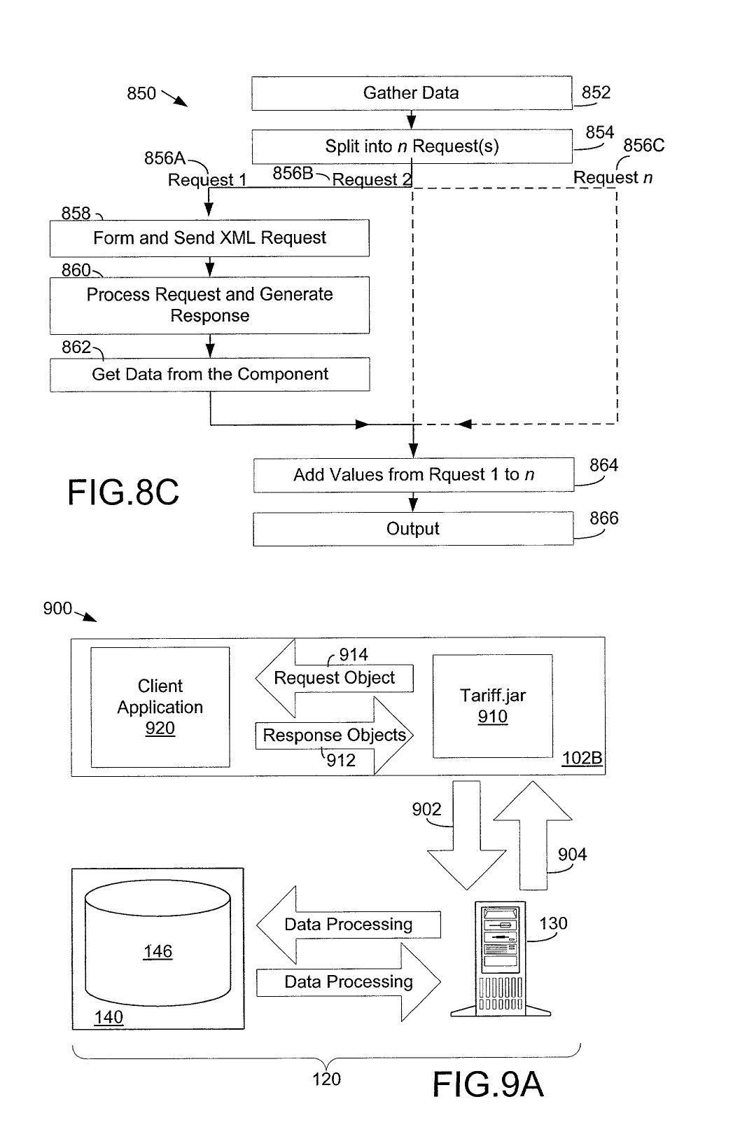

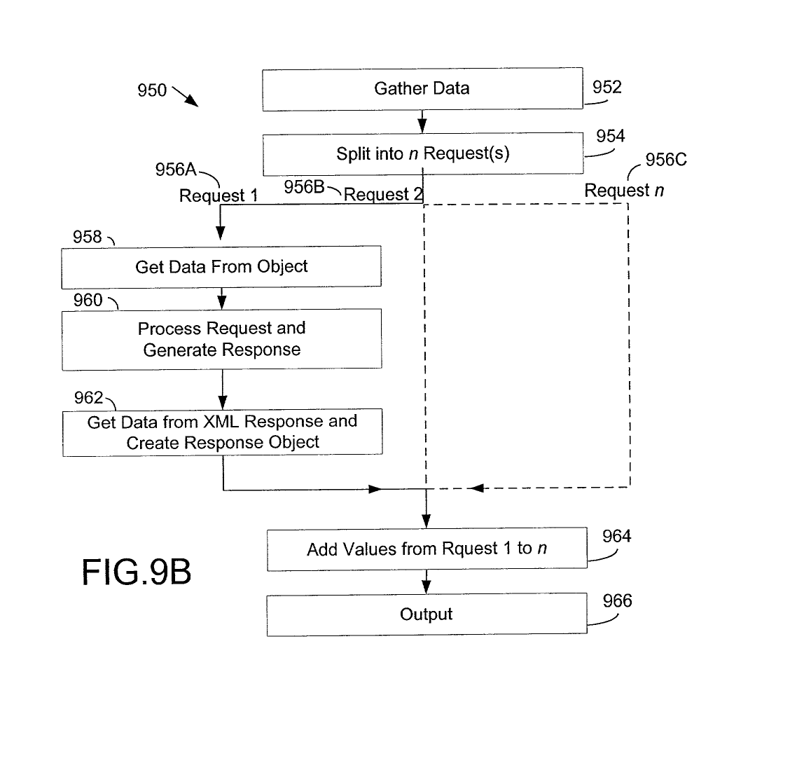

The flow diagram of FIG. 6 illustrates a process 600 used to manage users that access services provided by the real-time tariff and import data system 120. First, a user operating client device 120A that wishes to use the services completes request form 802 (see FIG. 8A), which is made available on the real-time tariff and import data system 120 Web site. The form 802 is sent to the Web server, 132 or 134, and processed by a dynamically generated page using the TFeedClient object 402 (see FIG. 4). Next, a customer manager using device 602 accesses the reformed request 604 and validates the request by verifying the user properly entered required information contained in request form 802 (e.g., username and PIN 606). The application server 130 sends a user authorization 608 to client 102A. Customer manager 602 may open a customer (or user) account using device 602 via, for example, a Web interface. Customer manager 602, preferably, e-mails confirmation to the customer that an account has been opened. Thereafter, the customer can carry out transactions using the real-time tariff and import data system 120 by logging in, without interaction with the customer manager 602. In some cases, installation of client components may be required on the customer's client device, as described with respect to FIGS. 8A-9B.

In some embodiments, the real-time tariff and import data system 120 may be configured to bill its customers for usage, based on, for example, number of Web site hits, transactions processed, or requested outputs. Customer account related information (or billing data) may be stored in databases 146 (or other databases) and a mechanism may be established for customer access of the billing data. There are at least two possibilities in this area:

(1) a Web interface that gives access to a secure environment for billing data, or

(2) a replication of billing data within the real-time tariff and import data system 120, allowing for a connection between a billing database and an accounting system.

The billing data may be use or fee information contained in customer account-related tables. Preferably, the real-time tariff and import data system 120 Web site includes a management section where access to billing data is password restricted, but with proper access allows account access for billing, payment or status.

An activity log is preferably generated to monitor server operations, which may be used for billing, as well as other purposes. Activities logged with respect to server operations may include client related transaction or system performance information (e.g., errors, processor utilization, and so on). That is, a log file may contain information concerning the sources of requests (e.g., IP Addresses, PIN numbers), requested product data, the date of the request and the date and type of information responses sent to clients. This file could be used by network operations or information technology personnel to resolve operations problems. The activity log functionality may also include importing and maintenance information.

A significant part of the real-time tariff and import data system 120 Web site, outside of the database content and user functionality, is its security system. Access is denied to hackers and content is be protected to ensure that it remains precise and consistent. Thus, access to content is controlled, restore mechanisms are implemented, and content integrity is maintained.

The application servers 132 and 134 used in the preferred embodiment provide the best security technology of its kind, with secure, flexible, and easy-to-configure architecture. The application server secures network applications through known, optional encryption, authentication and authorization functions, based on secured SSL RSA sockets, X.509 digital certificates and access control lists (ACLs). Together, all of these security functions allow the system to determine the user of the provided services. Access to some application server 132 or 134 services is controlled through user and user group definition. The term “user” refers to a human (e.g., a customer), a computer application, client device or a remote server. This security technology may be extended to all types of devices and users that access server resources.

ACLs are data structures that control access to resources. Each control list entry contains a set of access permission parameters associated with a user or a user group. Access permission allows the system to carry out certain kinds of operations on server resources. Access permission may be positive (i.e., authorization for certain kinds of operations on specific objects) or negative (i.e., prohibition of some operations on specific objects).

The application servers may be configured for a variety of levels of authentication. In the preferred form, application servers 132 and 134 are configured to use at least one of two processes to authenticate the users: passwords and encryption certificates. For minimal authentication, the process based on the password allows users to provide a password and their user name to access server resources. This process is based on the authentication process defined in the HTTP protocol. A drawback to this process lies in the fact that passwords and usernames are traveling over the Internet in plain text format. For a more comprehensive and powerful authentication system, in the preferred embodiment, encryption is used in the form of encryption certificates. These certificates are issued by a Certificate Authority (CA), such those certificates issued by Verisign, Inc. of Mountain View, Calif.

It is important to ensure that the information that passes through the Internet network circulates in an encrypted channel, and thus cannot be seen or altered. Therefore, application servers 132 and 134 include an SSL implementation used in distributed applications, such as 128-bit SSL Global Server IDs by Verisign. SSL Version 3 allows for connection encryption and is the standard default protocol used to establish private and encrypted communications between two applications within a non-secured network. A digital certificate (or digital ID) is required on the server (e.g., server 132 or 134) for this protocol. A digital certificate allows the server to prove its identity with clients or other servers before a private connection is established. Moreover, for greater security, application servers 132 and 134 can be configured to provide two-way authentication for clients and browsers. In those cases, two-way authentication requires that the client system to have a digital certificate. Digital certificates are then cross-authenticated.

Part II—Preparing and Processing Requests

In order to properly prepare the duty, import tax, or total landed cost of an item, a preferred set of transaction related inputs are required. Preferably, as discussed above, a request is sent from a client (e.g., client device 102) to the real-time tariff and import data system 120 via a Web site interface. In such an embodiment, the real-time tariff and import data system 120 guides the user to enter all needed inputs of the client by providing a well-structured request template or form with syntactic and semantic validation. Table 3 provides the preferred input requirements and their definitions for the request. (See also Appendix H for more information about input validation). The client's request is processed by application servers 132 and 134 of the real-time tariff and import data system 120. After processing, the real-time tariff and import data system 120 returns a response to the client.

TABLE 3
User Inputs

| Parameter | Definition |
|---|---|
| PIN Number | Personal identification number of the client provided |
| | by real-time customs tariffs and import data system |
| | 120. |
| Access Code | A code that specifies whether the duties and taxes |
| | are calculated within or over a volume quota for a |
| | specific product in a specific country. If |
| | the specific quota is not known by the client, |
| | the client choose “Without” from the |
| | Web page request form. (See Appendix F). |
| Origin Country | The country where the product is considered to be |
| | manufactured. If the product(s) are classified |
| | by the real-time tariff and import data system |
| | 120, this input is optional since it already |
| | resides in database 146 for each HS code. |
| | Otherwise, an origin country code is entered |
| | in the request and the country code in database |
| | 146 is not used. See Appendix A/B for a sample |
| | of countries and corresponding country codes. |
| Shipment Country | The country from where product(s) are sent (i.e., |
| | the country of exportation). See Appendix A/B. |
| Destination Country | The country to where products are sent (i.e., |
| | country of importation). See Appendix A/B. |
| Input Code Type | A code that represents the type of input |
| | specified for the Product Code parameter in the |
| | request. See Appendix G. |
| Product Code | Either user defined product code or the |
| | established HS code in the system database. If a |
| | user-defined product code is entered, that user |
| | defined product code is used for the entire |
| | transaction. If the user uses an HS code, a valid HS |
| | code of the destination country is required. |
| Transaction Value | Value of goods in the currency specified |
| | as the transaction currency parameter. |
| Number of Units | Number of units specified for the Unit |
| | Code parameter. |
| Unit Code | If a user-defined product code is entered, |
| | a unit code (see Appendix C) and corresponding unit |
| | type (see Appendix D) specified by real-time tariff |
| | and import data system 120 must be entered. If an |
| | HS code was entered, the appropriate unit code and |
| | corresponding unit type are required. The user may |
| | be requested to send up to 10 different Unit Codes |
| | and Numbers of Units, in the preferred form. |
| Cost of Transport | The cost of transportation, in the currency |
| | specified for the transaction currency parameter. In |
| | some embodiments, this parameter may be |
| | generated upon request by the real-time tariff and |
| | import data system 120 or a third party system |
| | coupled thereto. |
| Insurance Cost | The cost of insurance, in the currency |
| | specified for the transaction currency parameter. In |
| | some embodiments, this parameter may be |
| | generated upon request by the real-time tariff |
| | and import data system 120 or a third party |
| | system coupled thereto. |
| Other Costs | The amount of other costs, in the currency |
| | specified for the transaction currency parameter. |
| Transaction | The currency code used for the amount |
| Currency | specified for the transaction (e.g., U.S. Dollars). See |
| | Appendix A/B. |
| Conversion | The currency code used for the results |
| Currency | to be provided by real-time tariff and import data |
| | system 120, for any output format under which |
| | dollar amounts are presented. See Appendix A/B. |
| Output Format | Selected by entry of one of the predefined |
| | output format codes provided by real-time tariff and |
| | import data system 120. See Appendix E. |

In the preferred embodiment, a user can obtain the duty, tax and total landed cost associated with an international sale and shipment of one or more products by entering the above inputs. Preferably, the real-time tariff and import data system 120 guides the user to properly enter inputs. When entering the required inputs (previously discussed), the user determines whether to use its own product codes or standard HS codes in the request. If the user uses its own product codes in requests, those product codes can be entered into the system during a classification phase, as part of a user/customer account setup, so that they will be recognized when forming requests. Thereafter, the user can send requests using its own set of codes or the HS codes, either will be valid for the specified unit type. If real-time tariff and import data system 120 also requires a weight unit for the entered product, the request can contain any valid unit code representing a weight: grams, kilograms, pounds, and so on.

The real-time tariff and import data system 120 requires all measurement units to precisely calculate duties and taxes. Even when using HS codes in the request, the user must include all required units. If a unit is omitted, real-time tariff and import data system 120 returns an error message indicating that a unit is missing. For example, certain countries require more than one measurement unit to calculate duties and taxes, or have “multiple units”. For example, assume that a user plans to import wine from the United States to Canada. Canadian authorities calculate duties and taxes depending on the number of wine bottles being imported and the volume of pure alcohol. Therefore, the user needs to send two unit types in the request: a number of wine bottles and pure alcohol volume.

The real-time tariff and import data system 120 provides a default unit code for each unit type known to the system, see Appendix D. When referring to Appendix D, the “Unit Base” row column represents the default unit code. All other unit codes from the same unit type have a conversion factor based on the default unit code. Specifying the default unit code in the request typically reduces the response time, since the real-time tariff and import data system 120 will not need to perform a units conversion.

In the preferred embodiment, there are at least three methods for exchanging data between users' (e.g., customers with accounts) client devices and the real-time tariff and import data system 120 Web site. These methods provide users with a large range of request structure possibilities. According to these methods, a client may be a Web user client 102A, a Java client 102B, and/or a client using XML string102C, as examples. Because of its open-ended, flexible and self-descriptive characteristics, the preferred embodiment uses XML technology to exchange information with each type of client device. Thus, an XML format for the information exchanged between the clients and the real-time tariff and import data system 120 Web site is defined. That is, XML is used as a universal data exchange format, regardless of the type of client, as defined below.

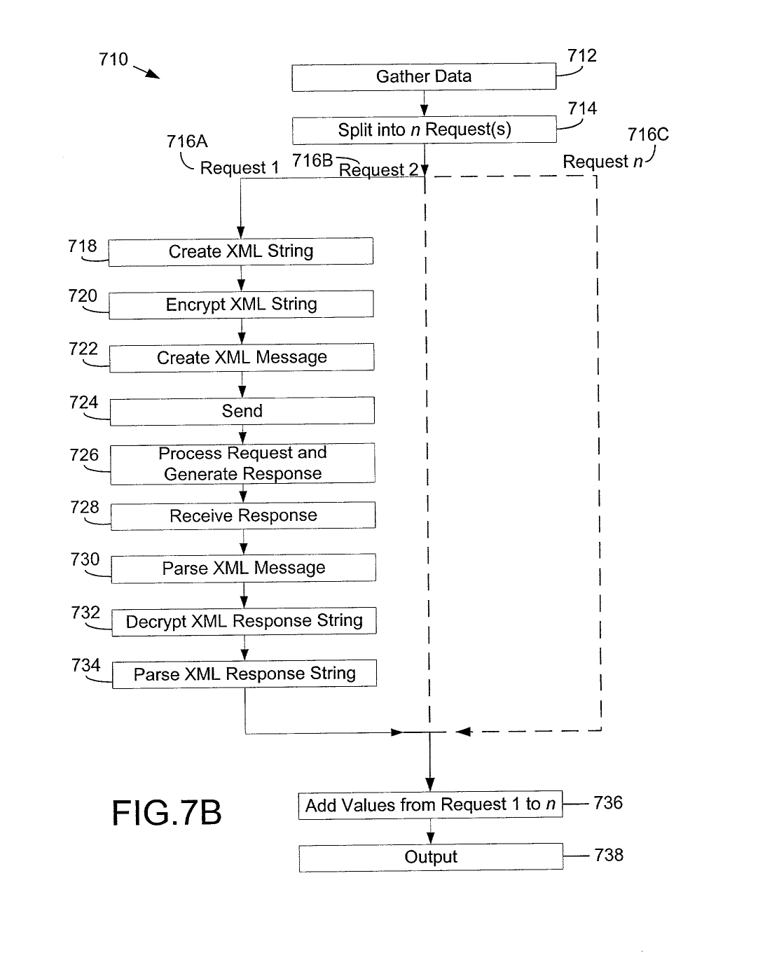

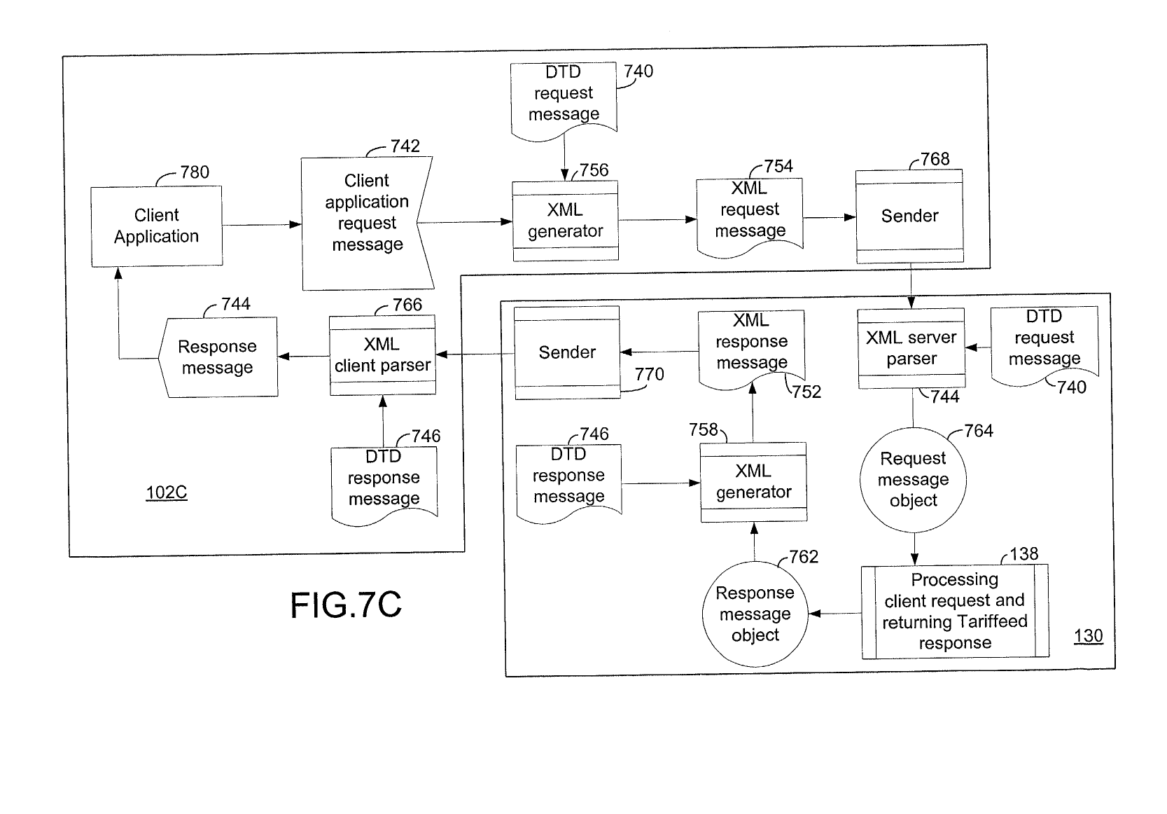

1. XML Clients—To accommodate access by XML clients 102C, the real-time tariff and import data system 120 provides an HTTP service that accepts user inputs as part of a text/XML request from a client, as can be appreciated with respect to FIGS. 7A-C. XML technology is used because it is supported by a variety of programming languages and by Web scripts, such as VBscript or Javascript. XML technology is derived from SGML, a relative of HTML, and defines a syntax for understanding and a format for data processing information. XML syntax includes a series of tags used to insert markers into a document, and is generally known in the art. For example <Product> marks the beginning of the definition of a product and </product> marks the end. A product definition in XML can be written as follows:

<product hscode=“12124560” country=“ca” quantity=“5000”/>

Once analyzed, this XML block will be interpreted as an entity containing three attributes: “hscode,” “country,” and “quantity.” An application can directly retrieve the value of a particular attribute without taking into account the order of the attributes within the document.

Generally, XML technology is open-ended and flexible. For example, an attribute “Price” may be added to a Document Type Definition (DTD) document in order to support the specific needs of a new client application, but the existing client applications would not be affected, since they would continue to search for valid, previously defined attributes. The DTD document is used to validate its corresponding XML documents, thus ensuring that the XML format respects the format specified in the DTD document, so is much less prone to having or causing errors. An XML document can be defined without using a DTD document, but use of a DTD document is preferred. Generally, applications access an XML document using a series of functions defined in a DOM (Document Object Model). A DOM is an XML application that provides a standard programming interface that allows an application to use the information defined within an XML document. FIG. 7A illustrates, at a top level, the interaction between the real-time tariff and import data system 120 and XML client 102C. An XML request message including an XML request string 702 is sent to and processed by server cluster 130 (including servers 132 and 134). Server cluster 130 returns an XML response message including an XML response string 704, as discussed in further detail below.

The communication between client device 102C and real-time tariff and import data system 120 is shown in flowchart 710 of FIG. 7B. FIG. 7C shows a detailed view of the components involved in carrying out the steps of flowchart 710. In step 712, a client application 780 of client 102C gathers user input data to generate one or more client application request messages 742. In step 714 of FIG. 7C, using the data, the client application 780 generates a plurality of requests, i.e., Request 1 716A, Request 2 716B, and Request n 716C. When possible, generating multiple requests allows for more efficient, parallel processing. An XML generator in 756 uses a request message DTD 740 and the client application request message 742 to generate an XML request message 754. To create the XML request message, for each request, an XML request string 702 is created, in step 718. Preferably, the XML request string 702 is encrypted in step 720 and, in step 722, XML request message 754 is formed. In step 724, a sender 768 transmits XML request message 768 to server cluster 130.

Several components included on the real-time tariff and import data system servers, i.e., server cluster 130, facilitate communication with client 102C. Server cluster 130 receives the XML request message 754 from sender 768. The received XML request message 754 is parsed by an XML server parser 744. A parser is a tool used for grammatical analysis, which includes a syntax analyzer, that can interpret tags and retrieve information from them. Generally, the parser performs on a document in accordance with a corresponding DTD, which contains a tag description used in the XML document being parsed. Thus, a DTD document (e.g., DTD request message document 740) specifies the particular XML format for XML request message 754, identifying the tags that may or may not appear in XML document 754.

XML server parser 744 decrypts the XML request string 702 contained within XML request message 754 and then parses XML request string 702. Parser 744 extracts input values and security attributes from the request XML request string 702, assuming security mechanisms are used. After the security attributes have been approved, the real-time tariff and import data system 120 matches the user input product code with the appropriate HS code in database 146, assuming a user-defined product code was not entered. If using an HS code, system 120 validates that the HS code is correct for the specified destination country. If an error occurs, an XML response string containing the error message is sent back to the client 102C. Errors may be caused by invalid XML request values, invalid XML request node names, invalid inputs or invalid security attributes, as examples.

Parsing XML request string 702 allows a request message object 764 to be created and passed to the real-time tariff and import data system application 138. The user's values, and any other needed values, are extracted and the duty calculation engine 412, tax calculation engine 418, and total landed cost engine 426 process the request, as required, in step 726, to produce a response message object 762. XML generator 758 generates an XML response message 752 from the response message object 762 and a DTD response message document 746. A sender 770 transmits the XML response message 770 to client device 102C.

Returning to flowchart 710 of FIG. 7B, client device 102C receives the XML response message 752, in step 728. XML client parser 766 on client 102C parses the XML response message 752, in step 730, to obtain the XML response string 704 and then decrypts the XML response string, in step 732. XML client parser 766 creates a response message 744 from XML response string 704 and DTD response message document 746 (which is also available to client 102C). Response message 744 includes the requested duty, tax, and/or total landed cost data and is passed to client application 780.

Implementation of the preferred approach to processing XML documents (i.e., requests and responses) takes place in several steps:

(1) Definition of DTD document 740 for requests from clients,

(2) Definition of DTD document for responses 746 from the real-time tariff and import data system 120, and

(3) Implementation of XML parsers (e.g., parsers 744 and 766), which retrieve data from XML documents and convert the data into objects.

As mentioned, a DTD document 740 is used to create the structure of the XML request string (see Appendix L). The DTD document 740 ensures that the request is properly formed for processing by the real-time tariff and import data system 120. The following is an example of a valid XML request message 754 prepared and sent by XML client 102C:

<!DOCTYPE TARlFFMESSAGE SYSTEM

“HTTP://WWW.WEBSITE.COM:7001/MESSAGE.DTD”>

<TARIFFMESSAGE ENCRYPTIONMETHOD=“1”

DTDVERSION = “1” >

<![CDATA[ ENCODED XML REQUEST]]>

</TARIFFMESSAGE>

The Text attribute ([CDATA[ . . . ]]) in the TariffMessage request contains a valid XML

request string encrypted with a secret key that is provided to clients. An example of a valid XML
request string (before it is encoded) is as follows:

<!DOCTYPE TFEEDREQUEST SYSTEM

“HTTP://WWW.WEBSITE.COM:7001/TARREQUEST.DTD”>

<TFEEDREQUEST>

PIN = “XXXX”
ORIGINCOUNTRY = “CA”
SHIPMENTCOUNTRY = “CA”
DESTINATIONCOUNTRY = “CG”

OUTPUTFORMAT = ”1”>

| <CURRENCY | TRANSACTIONCUR = “CAD” |
|---|---|
| | CONVERSIONCUR = “CAD”/> |
| <DTREQUEST | ACCESSCODE = “2” INPUTCODETYPE = “1” |

PRODUCTCODE = “010111” VALUE = “500000” COSTOFTRANSPORT = “50”
INSURANCECOST = “50” OTHERCOST = “50”>

<UNITS>
<UNIT NBOFUNIT = “1” UNITCODE = “4”/>
</UNITS>

</DTREQUEST>

</TFEEDREQUEST>

An example of XML response string is as follows:

<!DOCTYPE TFEEDREPLYSYSTEM

“HTTP://WWW.WEBSITE.COM/TARREPLY.DTD”>

<TFEEDREPLY>
<TFEEDREPLY STATUS = “0” HSCODE = “1212121212” MESSAGE = “OK” NOTES = ““>

<DUTY DUTY = “500”/>

</TFEEDREPLY>

2. Web (i.e., ActiveX/COM) Clients—The real-time tariff and import data system 120 accommodates Web clients 102A using ActiveX/COM components, as shown in FIGS. 8A-C. With this type of client, a standard Web browser 806 is used by the client 102A, as is shown in FIG. 8A. Using a browser, a client 102A generates a request 802, e.g., an HTML form, and transmits the request 802 to the real-time tariff and import data system 120. Request 802 is serviced by the application servers 130. Request 802 contains all of the required information for conducting duty, import tax, and/or total landed cost calculations, depending on the user's selected output. Request 802 is well formed, since the client is prompted to enter all inputs needed to process the request and the inputs are preferably validated. As discussed with respect to FIG. 4, a servlet 424 on server cluster 130 picks up request 802, retrieves the data (i.e., inputs) and processes the request by calculating the requested duty, import tax and/or total landed cost.

A more detailed view of the configuration of client 102A is shown in FIG. 8B. An ActiveX/COM component 810 is loaded onto client device 102A to make the functionality of the real-time tariff and import data system 120 available to the client application 820, via Web browser 806. Functionally, component 810 acts as a translator between the client's Web-based application 820 and the real-time tariff and import data system 120 functionality. Component 810 simplifies processing by translating client application requests into XML requests 802. All of the XML formatting and encryption is done by component 810. Loading component 810 on client 102A may require registration with the real-time tariff and import data system 120, depending on the embodiment. To use component 810, an encryption method is set internally, when encryption is used. The encryption method defines the encryption key to be used for communication with the real-time tariff and import data system 120. Setting the encryption method is accomplished using the appropriate “set” methods of component 810.

Additionally, inputs 812 entered via the client's Web-based application 820 are incorporated into XML request 802 using appropriate set methods of component 810. Use of such set methods for assigning attribute values is known in the art, so not discussed in detail herein. The following is a preferred embodiment of an interface definition used by the ActiveX/COM component 810 with client application 820:

interface ISingleRequestSession : IDispatch
{
HRESULT ProcessRequest( );
HRESULT setEncryptionKey([in] BSTR EncryptionKey);
HRESULT setEncryptionMethod([in] BSTR EncryptionMethod);
HRESULT setDtdVersion([in] BSTR DtdVersion);
HRESULT getHSCode([out,retval] BSTR* USCode);
HRESULT getStatus([out,retval] BSTR* Status);
HRESULT getMessage([out,retval] BSTR* Message);
HRESULT getCustomTarifRate([out,retval] BSTR*

CustomTarifkate);

HRESULT getPerUnitCusTarif([out,retval] BSTR* PerUnitCusTarif);
HRESULT getProductBaseUnit([out,retval] BSTR *

ProductBaseunit);

HRESULT getDutyAmount([out,retval] BSTR * DutyAmount);
HRESULT getTaxCount([out,retval] int* TaxCount);
HRESULT getCategory([in] int index,[out,retval] BSTR* Category);
HRESULT getTaxRate([in] int index,[out,retval] BSTR* TaxRate);
HRESULT getPerUnitTax([in] int index,[out,retval] BSTR*
PerUnitTax);
HRESULT getTaxBaseUnit([in] int index,[out,retval]

BSTR*TaxBaseUnit);

HRESULT getTaxAmount([in] int index,[out,retval] BSTR*

TaxAmount);

HRESULT getTaxName([in] int index,[out,retval] BSTR* TaxName);
HRESULT getSumTaxes([out,retval] BSTR* SumTaxes);
HRESULT getValue([out,retval] BSTR* Value);
HRESULT getCostOfTransport([out,retval] BSTR* CostOfTransport);
HRESULT getInsuranceCost([out,retval] BSTR* InsuranceCost);
HRESULT getOtherCosts([out,retval] BSTR* OtherCosts);
HRESULT getTotalLandedCost([out,retval] BSTR* TotalLandedCost);
HRESULT getServerAddress([out,retval] BSTR* ServerAddress);
HRESULT setPinNumber([in] BSTR PinNumber);
HRESULT setShipmentCountry([in] BSTR ShipmentCountry);
HRESULT setOriginCountry([in] BSTR OriginCountry);
HRESULT setDestinationCountry([in] BSTR DestinationCountry);
HRESULT setOutputFormat([in] BSTR OutputFormat);
HRESULT setProductCode([in] BSTR ProductCode);
HRESULT setValue([in] BSTR Value);
HRESULT setUnit([in] BSTR NbOfUnit, [in] BSTR UnitCode, [in] int
UnitIndex);
HRESULT setCostOfTransport([in] BSTR CostOfTransport);
HRESULT setInsuranceCost([in] BSTR InsuranceCost);
HRESULT setOtherCost([in] BSTR OtherCost);
HRESULT setCurrency([in] BSTR Currency);
HRESULT setConversionCurrency([in] BSTR ConversionCurrency);
HRESULT setInputCodeType([in] BSTR InputCodeType);
HRESULT setAccessCode([in] BSTR AccessCode);
HRESULT getNotes([out,retval] BSTR* Notes);
HRESULT getTaxNote([in] int index,[out,retval] BSTR* TaxNote);

FIG. 8C illustrates a client-side view of a method 850 of interaction between client 120A (with the ActiveX/COM component 810) and the real-time tariff and import data system 120. Component 810 receives inputs 812 and creates one or more corresponding requests 856A-C, in step 854, according to the appropriate DTD. Using the DTD minimizes the potential for XML errors, because the XML request string 802 built is inherently valid and well formed. Encryption and decryption will also be valid, minimizing the potential for encryption errors. As an example, the request 856A, in step 858, is formed into an XML request string 802, using a ProcessRequest( ) method of component 810. Component 810 sends XML request string 802 to server 132 and/or 134.

In step 860, the real-time tariff and import data system 120 processes the requests and returns an XML response to component 810. The response will be in the form of an XML response string 804 that provides duty, tax, and/or total landed cost values, in accordance with the user's selected output. Component 810 decrypts the XML response 804 with an appropriate encryption key (i.e., the public key of system 120). The XML response string 804 is then parsed by component 810. All values are extracted from the XML response string and set in the component. The client application retrieves desired values from the response by using the appropriate “get” method 814 for each value needed. Each response value has its appropriate “get” method. The values are combined in step 864 and provided to the client application 820, in step 866.

3. Java Clients—The real-time tariff and import data system 120 provides a set of Java classes, embodied in Tariff.jar 910, loaded on the client 102B that prepares and sends an XML request 902 to the server 132 or 134, as is shown in FIG. 9A. An application (e.g., client application 920) uses the Java classes 910 by calling one method to pass a request object 912 and by receiving a reply object 914. Using Java to prepare and send XML request string 902 is similar to the use of ActiveX/COM component 810 discussed above. Tariff.jar 910 acts as a translator between client application 920 and the real-time tariff and import data system 120. That is, Java classes 910 allow XML requests to be sent by client 102B and XML responses to be received by client 102B.

To use the Java classes 910, the classes must first be added to the client's class path or project environment, which makes the Java classes available to the client application 920. An encryption method and encryption key must also be set in the Tariff.jar 910 classes to facilitate secure communications. Thereafter, processing a request merely requires calling one method, ProcessRequest( ), and passing a request object containing the input parameters discussed previously (see also Appendix H).

The ProcessRequest( ) method of Tariff.jar 910 builds a valid XML request string from the user's inputs. This approach minimizes XML errors, since the XML request string will necessarily be valid and well formed according to its DTD. Also, given that the ProcessRequest( ) method builds the request, encryption and decryption will also be valid, minimizing encryption errors. After building the XML request string 902, the Java classes 910 send the XML request to servers 132 and 134, receives the XML response message, and decrypts the XML response string 904 therefrom. The Java classes 910 decrypt the XML response string 904 with the appropriate encryption key (e.g., system 120's public key).

The Java classes 910 parse the XML response string. All values are extracted from the XML response string 904 and set in the Java classes. A response object 914 is then returned to the client application 920. These values can be retrieved by the client application 920 by calling the appropriate “get” methods of the response object. Each response value has its appropriate “get” method. All values can be retrieved and output in client application 920.

FIG. 9B shows a client-side view of a method 950 of interaction between a client application 920 and server cluster 130. In step 952, the client application 920 gathers the inputs from the user and generates one or more request objects, 956A-C. In step 958, the Java classes 910 receive the request object 912 (or 956A) and gets the needed inputs from the request object and then creates an XML request string 902. The request string 902 is then sent (in an XML request message) to the real-time tariff and import data system 120 servers 132 and 134, which processes the request, in step 960. An XML response string (in a response message) is then returned to the Java classes 910 from the servers 132 and 134. The Java classes 910 get data from the XML response string and form response objects 914, in step 962. The response includes the duty, tax, and/or total landed cost, as requested by the user. The client application 920 retrieves values from the response objects 914 by calling the appropriate “get” methods and combines the values, in step 964. The values are then output to the client application 920, in step 966.

Part III—Calculations

The following is the preferred embodiment of the manner of calculating duties and taxes associated with an international transaction. The methods are implemented by the duty calculation engine 412, import tax calculation engine 418, and total landed cost calculation engine 426, previously discussed with respect to FIG. 4. The duty calculation engine 412 accesses relevant tariff rates for a specified product and destination country from the database 146 and applies the lowest of such applicable rates to arrive at a duty calculation. The import tax calculation engine 418 accesses relevant databases of country specific import tax rates, charges and fees and applies them to arrive at import tax costs. The total landed cost calculation engine 426 determines the total landed cost from the duty calculation and the import tax calculation, and any other relevant costs (e.g., transportation and insurance costs).

The inputs for the various engines are gathered from the XML request process previously described. The inputs for the various engines are described above in Part II and Appendix H. Validation of the inputs is performed as the data is input into appropriate fields of, for example, a Web-based request form. The validation occurs by testing inputs against field-based validation criteria, described in Appendix H. Appendix I identifies the returned values for each of the ten (10) possible output formats of the preferred embodiment.

1. Duty (or Tariff) Calculation

The following tables identify the steps taken by the duty calculation engine 412 to calculate the duty (or tariffs) for a given international transaction. At a macro level, the steps include selecting a duty rate, converting currencies, and calculating the duty fee. The tables include object oriented pseudo code describing calls and method steps used in the process and also describes error codes applicable to the various steps.

TABLE 4
Duty Rate Selection
below shows the steps for selecting a duty rate for a given set of inputs.

| Step | Processing |
|---|---|
| 1. Verify HS code | Tables: |
| | _TariffDescription = (Country.CountryCode of |
| | destination country) + “TarrifDescription” |
| | Information: |
| | _TariffDescription.HSCode |
| | _TariffDescription.UnitCode |
| | _TariffDescription.ApplicableTariff |
| | Selection criteria: |
| | _TariffDescription.HSCode = HS Code |
| | Error processing: |
| | If no record is returned: |
| | Error code: S110-The HS code is not in the HS |
| | code list for the destination country. |
| 2. Verify tariff | Tables: |
| preference | _TariffCode = (Country. CountryCode of |
| | destination country) + “TariffCode” |
| | _TariffScheme = (Country. CountryCode of |
| | destination country) + “TariffScheme” |
| | Information: |
| | _TariffCode.TariffCodeID |
| | _TariffCode.Acronym |
| | _TariffCode.GeneralTariff |
| | _TariffScheme.CountryCode (optional) |
| | Selection criteria: |
| | _TariffScheme.CountryCode = |
| | Country.CountryCode of |
| | country of origin of goods |
| | _TariffCode.Acronym in |
| | _TariffDescription.ApplicableTariff |
| | Error processing: |
| | If the Country code is not in the items returned |
| | by the request, the item containing the general |
| | tariff must be selected. |
| | Error code: S120-No Tariff code available. |
| | Error code S120 should be brought to the |
| | attention of the system administrator. |
| 3. Select Duty Rate | Required: |
| | The specified HS code must be a valid HS code |
| | (see Step 1). |
| | There is an applicable tariff code |
| | (_TariffCode.TariffCodeID<>NULL) (see |
| | Step 2). |
| | Table: |
| | _TariffData = (Country.CountryCode of |
| | destination country) + “TariffData” |
| | Information: |
| | _TariffData.AddValoremRate |
| | _TariffData.PerUnit |
| | _TariffData.CalculationMethod |
| | Selection criteria: |
| | _TariffData.HSCode = |
| | _TariffDescription.HSCode |
| | _TariffData.TariffCodeID = |
| | _TariffCode.TariffCodeID |
| | Selecting a tariff: |
| | If more than one rate is available, the |
| | application selects the highest. |
| | Error processing: |
| | If no tariff is returned: |
| | Error code: S130-No tariff code available for |
| | HS code specified in request. |
| | Error code S130 should be brought to the |
| | attention of the system administrator. |
| 4. Convert per-unit rate | Required for output formats 1, 3, 7 and 9 (See |
| | Appendix I) |
| | If the conversion currency of the request |
| | (Request.ConversionCur) is the same as the |
| | country’s customs tariff currency |
| | (Country.TariffsCurrency) Then |
| | ConvertedPerUnitRate = _TariffData.PerUnit |
| | Else If the country’s customs tariff currency is |
| | “USD” Then |
| | ConvertedPerUnitRate = Conversion of per- |
| | unit rate from “USD” to the conversion |
| | currency of the request (See Table 5) |
| | Else |
| | USDPerUnitRate = Conversion of per-unit rate |
| | to “USD” (See Table 5) |
| | ConvertedPerUnitRate = Conversion from |
| | USDPerUnitRate to the conversion currency of |
| | the request (See Table 5) |

TABLE 5
Currency Conversion
Table 5 shows the steps for converting between currencies among
countries, which is useful in the calculations, since typically
the origin country, shipment country, and destination country
may have different currencies.

| Step | Processing |
|---|---|
| 1. Find rate | Tables: |
| | Country |
| | Currency |
| | Information: |
| | Currency.Rate |
| | Selection criteria: |
| | Country.CountryCode = <Country ISO code> |
| | Currency.Code = <Currency ISO code> |
| | Note-the currency ISO code can come from: |
| | The request (TransactionCur; ConversionCur) |
| | The Country table (Country.CurrencyCode; |
| | Country.TariffsCurrency) |
| | Error processing: |
| | If no item is returned: |
| | S210-No exchange rate available for the |
| | following currency code: <Currency ISO code>. |
| | Error code S210 should be brought to the |
| | attention of the system administrator. |
| 2. Calculate converted | To convert to USD (as an example) |
| amount | Amount/Currency.Rate |
| | To convert from USD |
| | Amount * Currency.Rate |

TABLE 6
Duty Fee Calculation
Table 6 shows the steps br calculating the duty (or tariff), which
incorporates the steps in Table 4 for selecting a duty (or tariff)
and the steps of Table 5 for converting currencies.

| Step | Processing |
|---|---|
| 1. Select a tariff | See Table 4. |
| 2. Identify applicable | Table: |
| basis for duty | Country |
| calculation | CalculationBase |
| | Information: |
| | CalculationBase.CostOfGoods |
| | CalculationBase.Transport |
| | CalculationBase.InsuranceCost |
| | CalculationBase. OtherCost |
| | Selection criteria: |
| | Country.CountryCode = Destination Country |
| | code |
| | CalculationBase.CaculationBaseID = |
| | Country.DutyFeeCalculationBase |
| 3. Calculate applicable | Applicable Fees = 0 |
| duty | If CalculationBase.CostOfGoods is TRUE Then |
| | Applicable Fees = Request.PriceOfGoods |
| | If CalculationBase.Transport is TRUE Then |
| | Applicable Fees = Applicable Fees + |
| | Request.CostOfTransport |
| | If CalculationBase.InsuranceCost is TRUE Then |
| | Applicable Fees = Applicable Fees + |
| | Request.InsuranceCost |
| | If CalculationBase.OtherCost is TRUE Then |
| | Applicable Fees = Applicable Fees + |
| | Request.OtherCost |
| 4. Convert applicable | If the transaction currency |
| fees | (Request.TransactionCurrency) is |
| | the same as the country’s customs tariff currency |
| | (Country.TariffsCurrency) Then |
| | ConvertedApplicableFees = ApplicableFees |
| | Else If the transaction currency is “USD” Then |
| | ConvertedApplicableFees = Conversion of |
| | applicable fees from “USD” to the tariff currency |
| | (See Table 5) |
| | Else |
| | USDApplicableFees = Conversion of applicable |
| | fees to “USD” (See Table 5) |
| | ConvertedApplicableFees = Conversion of USD |
| | applicable fees to the tariff currency (See Table 5) |
| 5. Convert quantities | Tables: |
| | UnitCode |
| | _TariffDescription |
| | Information: |
| | UnitCode.UnitType |
| | UnitCode.ConversionFactor |
| | _TariffDescription.UnitCode |
| | Methods: |
| | If Request.ProductBaseUnit = |
| | _TariffDescription.UnitCode, Then |
| | ConvertedQuantity = Request.NbOfUnit |
| | Else If the unit type of Request.ProductBaseUnit |
| | is different from the type associated with the |
| | product unit measure; Then |
| | Error code: S560-The base unit of the products is |
| | incompatible with the base unit specified in the |
| | request. |
| | Else ConvertedQuantity = Request.NbOfUnit* |
| | UnitCode.ConversionFactor |
| | Remarks: To find out the base unit type, refer to |
| | the UnitCode.UnitType field. |
| 6. Calculate duty | AddValoremFee (ConvertedApplicableFees* |
| | _TariffData.AddValoremRate) |
| | PerUnitFee = (ConvertedQuantity* |
| | _TariffData.PerUnit) |
| | If the tariff calculation method is “Applied Both” |
| | (_TariffData. CalculationMethod = 10 Then |
| | DutyFee = AddValoremFee + PerUnitFee |
| | Else If the tariff calculation method is “Applied |
| | Greatest” |
| | (_TariffData.CalculationMethod = 20) Then |
| | If Add ValoremFee>PerUnitFee Then |
| | DutyFee = AddValorenffee |
| | Else |
| | DutyFee = PerUnitFee |
| | Else If the tariff calculation method is “Applied |
| | Smallest” |
| | (_TariffData.CalculationMethod = 30) Then |
| | If AddValoremFee>PerUnitFee Then |
| | DutyFee = PerUnitFee |
| | Else |
| | DutyFee = AddValoremFee |
| 7. Convert duty | If the conversion currency of the request |
| | (Request.ConversionCur) is the same as the |
| | country’s customs tariff currency |
| | (Country.TariffsCurrency) Then |
| | ConvertedDutyFee = DutyFee |
| | Else If the country’s customs tariff currency is |
| | “USD”Then ConvertedDutyFee = Conversion of |
| | duty fee from “USD” to the conversion currency |
| | of the request (See Table 5) |
| | Else |
| | USDDutyFee = Conversion of duty fee from |
| | “USD” (See Table 5) |
| | ConvertedDutyFee = Conversion of USD duty |
| | fee to the conversion currency of the request |
| | (See Table 5) |

2. Tax Calculation

The following tables identify the steps taken by the import tax calculation engine 418 to calculate the tax for a given international transaction. At a macro level, the steps include selecting a tax rate and calculating the applicable taxes. The tables include object oriented pseudo code describing calls and method steps, and also describes error codes for the various steps.

TABLE 7
Tax Rate Selection
Table 7 below, shows the steps for selecting a tax rate for a given
set of inputs.

| Step | Processing |
|---|---|
| 1. Verify HS code | Table: |
| | HSDescription |
| | Information: |
| | HSDescription.HSCode |
| | Selection criteria: |
| | HSDescription.HSCode = Input.HS Code[1:6] |
| | Error processing: |
| | If no record is returned: |
| | Error code: S410-The HS code is not in the standard |
| | HS code list. |
| 2. Identify | Tables: |
| categories | HSCategoryInterval |
| | Information: |
| | HSCategorylnterval.CategoryID |
| | Selection criteria: |
| | HSCategorylnterval.HSFrom >= Input.HS |
| | Code[1:6] |
| | HSCategorylnterval.HSTo <= Input.HSCode[1:6] |
| | Error processing: |
| | If no category is returned: |
| | Error code: S420-The product does not belong to |
| | any product category. |
| | Error code S420 should be brought to the attention |
| | of the system administrator. |
| 3. Select applicable | Tables: |
| taxes | ApplicableTax |
| | Tax |
| | Information: |
| | Tax.TaxeAcronym |
| | Tax.TaxeRate |
| | Tax.TaxePerUnit |
| | Tax.TaxeUnitBase |
| | Method: |
| | For each category identified in the previous step: |
| | Select all taxes applicable to the category. |
| | Eliminate those taxes that were selected more than |
| | once (duplicates). |
| 4. Convert per-unit | Applicable to output formats 4, 6, 7 and 9 |
| taxes | For each tax selected, the applicable per-unit tax |
| | must be converted if it is greater than zero. |
| | If the conversion currency of the request |
| | (Request.ConversionCurrency) is the same as the |
| | country’s customs tariff currency |
| | (Country.TariffsCurrency) Then |
| | ConvertedPerUnitTax = Taxe.TaxPerUnit |
| | Else If the country’s customs tariff currency is |
| | “USD” Then ConvertedPerUnitTax = Conversion of |
| | per-unit tax from “USD” to the conversion currency |
| | of the request (See Table 5) |
| | Else |
| | USDPerUnitTax = Conversion of per-unit tax to |
| | “USD (See Table 5) |
| | ConvertedPerUnitTax = Conversion of |
| | USDPerUnitTax to the conversion currency of the |
| | request (See Table 5) |

Table 8 shows the steps for calculating the import tax, which incorporates the steps in Table 6 for selecting a tax rate and the steps of Table 5 for converting currencies.

TABLE 8
Import Tax Calculation

| Step | Processing |
|---|---|
| 1. Select applicable | See Table 7. |
| taxes | |
| 2. Identify applicable | Tables: |
| basis for tax | Tax |
| calculation | CalculationBase |
| | Information: |
| | CalculationBase.CostOfGoods |
| | CalculationBase.Transport |
| | CalculationBase.InsuranceCost |
| | CalculationBase. OtherCost |
| | CalculationBase.DutyFee |
| | Selection criteria: |
| | CalculationBase.CalculationBaseID = |
| | Tax.TaxCalculationBase |
| 3. Calculate taxable | Taxable Fees = 0 |
| fees | If CalculationBase.CostOfGoods is TRUE Then |
| | Taxable Fees = Taxable Fees + Request.Value |
| | If CalculationBase.Transport is TRUE Then |
| | Taxable Fees = Taxable Fees + |
| | Request.CostOfTransport |
| | If CalculationBase.InsuranceCost is TRUE Then |
| | Taxable Fees = Taxable Fees + |
| | Request.InsuranceCost |
| | If CalculationBase.OtherCost is TRUE Then |
| | Taxable Fees = Taxable Fees + |
| | Requête.OtherCost |
| | If CalculationlBase.DutyFees is TRUE Then |
| | Taxable Fees = Taxable Fees + Calculated |
| | Duty Fee (See Table 6) |
| 4. Calculate surtax on | Note: It is important to verify that a given tax is |
| taxes | not applied as a surtax on a second tax which is |
| | itself applied to the first tax. In the event of such |
| | a loop, an error code must be returned. |
| | Error code: S440-System error. Unable to |
| | calculate taxes. |
| | Error code S440 should be brought to the |
| | attention of the system administrator along with |
| | the information pertaining to the request. |
| | Calculate the tax with surtax. |
| | Add the resulting amount to the Taxable Fees. |
| | Repeat the operation for all taxes on which a |
| | surtax applies. |
| 5. Convert taxable fees | If the transaction currency |
| | (Request.TransactionCur) is the same as the |
| | country’s customs tariff currency |
| | (Country.TariffsCurrency) Then |
| | ConvertedTaxableFees = ApplicableFees |
| | Else If the transaction currency is “USD” Then |
| | ConvertedTaxableFees = Conversion of taxable |
| | fees from “USD” to the tariff currency |
| | (See Table 5) |
| | Else |
| | USDTaxableFees = Conversion of to “USD” (See |
| | Table 5) |
| | ConvertedTaxableFees = Conversion of USD |
| | taxable fees to the tariff currency (See Table 5) |
| 6. Convert quantities | Table: |
| | UnitCode |
| | Tax |
| | Information: |
| | UnitCode.UnitType |
| | UnitCode.ConversionFactor |
| | Tax.UnitCode |
| | Methods: |
| | If Request.ProductBaseUnit = Tax.UnitCode |
| | Then ConvertedQuantity = Request.NbOfUnit |
| | Else If the unit type of Request.ProductBaseUnit |
| | is different from the type associated with the |
| | product base unit Then Error code: S560-The base |
| | unit of the products is incompatible with the |
| | base unit specified in the request. |
| | Else ConvertedQuantity = Request.NbOfUnit* |
| | UnitCode.ConversionFactor |
| | Remarks: |
| | To find out the base unit type, refer to the |
| | UnitCode.UnitType field. |
| 7. Calculate taxes | TransactionTax = (Converted Taxable Fees * |
| | Tax.TaxeRate) UnitTax = (ConvertedQuantity * |
| | Tax.TaxPerUnit) If the tax calculation method is |
| | “Apply Both”(Tax.CalculationMethod) = |
| | 10 Then Tax = TransactionTax + |
| | Unit Tax |
| | Else If the tax calculation method is “Applied |
| | Greatest” (Tax.CalculationMethod = 20) |
| | Alors If Transaction Tax>Unit Tax Then Tax = |
| | Transaction Tax |
| | Else |
| | Tax = Unit Tax |
| | Else If the tax calculation method is “Applied |
| | Smallest” (Tax.CalculationMethod = 30) Then |
| | If Transaction Tax>Unit Tax Then |
| | Tax = Unit Tax |
| | Else |
| | Tax = Transaction Tax |
| 8. Convert taxes | If the conversion currency of the request |
| | (Request.ConversionCurrency) is the same as |
| | the country’s customs tariff currency |
| | (Country.TariffsCurrency) Then |
| | ConvertedTax = Tax |
| | Else If the country’s customs tariff currency is |
| | “USD” Then ConvertedTax Conversion of taxes |
| | from “USD” to the conversion currency of the |
| | request (See Table 5) |
| | Else |
| | USDTax = Conversion of taxes to “USD” (See |
| | Table 5) |
| | ConvertedTax Conversion of USDTax to the |
| | conversion currency of the request (See Table 5) |

3. Total Landed Cost (TLC) Calculation

The TLC engine uses the output from the duty calculation engine and the tax calculation engine, along with user inputs described in Part II, to arrive at a total landed cost, as follows:

TLC=Duty Fee+Import Taxes+Price of Goods+Cost of Transport+Insurance Costs+Other Costs

Part IV—MUT™ System and Method

A MUT™ system and method may be included as a part of the real-time tariff and import data system or as a standalone system that may be configured to interface with the real-time tariff and import data system or with an e-commerce system. The MUT™ system simplifies the task of classifying products and mitigates potential complications arising from contradictorily defined HS code extensions among various countries. That is, the MUT™ system provides a manner of maximizing compatibility of HS-based codes across countries and avoiding errors in the coding of products for international transactions. The existing HS scheme is preserved and, to the maximum extent possible, for each product a single, unique global MUT™ code is defined that is compatible with the country specific HS-based product codes of all trading countries. Users, such as retailers, manufacturers, and distributors can create a database for their product offerings that comply with the global MUT™ codes, and used in transactions.

The global MUT™ codes and country specific local MUT™ codes may be formed as described below. Each global MUT™ code includes the base HS code plus MUT™ system extensions. The particular extensions used by the MUT™ system are determined as a function of an evaluation of the HS code extensions defined by substantially all countries that use the HS for each product. Generally, the following steps are implemented to define MUT™ codes:

1. Analyze and extract all of the product differentiation (by category and value) currently being defined in product code extensions by each country for each of its trading products.

2. Consolidate all the categories and values, defined by every country for every product having the same base HS code.

3. Codify a global MUT™ code format for every base HS code and generate corresponding local MUT™ codes for each country, according to the categories consolidated in the previous step.

4. Validate the global MUT™ code based on the codification performed in the previous step.

1. Analysis of the Actual Country Schemes

To establish a MUT™ code that uniquely and precisely identifies a product in substantially every country, the product codes of each country are obtained and analysis is performed to extract all product differentiation embodied in the extensions to the base HS product codes. Differentiation is accomplished within extensions by category and value. A category is a product attribute (e.g., color) defined, for example, by a digit pair (e.g., digits 7 and 8). There may be several values for each category (e.g., red, green, and blue). A value is represented in the digit pair numerically (e.g., a country may have defined values for digit pair 7 and 8 of “00”, “10”, “20” and “30”). For each product of a given country having the same base HS code, product codes (i.e., HS base code+extensions) are obtained. Each country may have defined different categories and values for each product of a certain base HS code, yielding a plurality of country defined product codes having different extensions (i.e., the same or different categories with the same or different values).

For example, the base HS code for “toys made for plastic, doll” may be 506070 for all countries. And, in the United States (US), toys made of plastic, doll may include 2 categories: (1) digit pair 7 and 8: head attribute and (2) digit pair 9 and 10: color. The values of the head attribute may be: with hair=10; and without hair=20. The values of the category for color may be: black=10; blonde=20; other=90, and not applicable=00, as is shown in Table 9A.

TABLE 9A
U.S. Product Codes (sample)
Country: US

| HS | Description past 6 digit |
|---|---|
| 5060701010 | with hair, blond |
| 5060701020 | with hair, black |
| 5060701090 | with hair, other color |
| 5060702000 | without hair |

Other countries may define categories and values differently, beyond the base HS code. For example, for the same base HS code of 506070 for toys made of plastic, doll, Canada may define the following categories: (1) digit pair 7 and 8: gender, (2) digit pair 9 and 10: clothing, and (3) digits 11 and 12; accessories. A product code table for Canada is shown in Table 9B.

TABLE 9B
Canadian Product Codes (sample)
Country: Canada

| HS | Description past 6 digit |
|---|---|
| 506070101010 | male, dressed, with accessories |
| 506070101020 | male, dressed, without accessories |
| 506070102000 | male, undressed |
| 506070201010 | female, dressed, with accessories |
| 506070201020 | female, dressed, without accessories |
| 506070202000 | female, undressed |

As yet another example, for the same base HS code of 506070 for toys made of plastic, doll, Mexico may define the following categories: (1) digit pair 7 and 8: gender, (2) digit pair 9 and 10: head attribute, and (3) digits 11 and 12: color. A product code table for Mexico is shown in Table 9C.

TABLE 9C
Mexican Product Codes (sample)
Country: Mexico

| HS | Description past 6 digit |
|---|---|
| 506070101010 | male, with hair, black |
| 506070101090 | male, with hair, other |
| 506070109000 | male, other |
| 506070201010 | female, with hair, black |
| 506070201020 | female, with hair, blonde |
| 506070201030 | female, with hair, blue |
| 506070201090 | female, with hair, other |
| 506070209000 | female, other |

After the categories and values of several countries have been extracted, virtually all product distinctions have been identified and covered; that is all categories and values have typically been determined.

2. Category Codification

After all categories and values have been extracted, category codification is then performed. That is, all categories and values defined by every country for every product are analyzed and, to the maximum extent possible, they are consolidated. This process may include the following:

(1) The previously extracted categories are grouped (or unified) and redundancies are eliminated.

(2) After category unification, the possible values for each category are consolidated, to ensure that each category value (for a given category) is MUT™ually exclusive and unique, thus, blonde=10 and blonde=20 does not occur, for example.

(3) A numerical value is assigned to every value in the category (e.g., for category color, values: black=10, blonde=20, other=90).

(4) A “special” value is also created for each category; the special value is “not applicable”, which may be coded as “00”.

Using the above example, the categories head attribute, color, gender, clothing, and accessories result. The following categories and values are defined:

a. head attribute

| | |
|---|---|
| i) | 10 = with hair |
| ii) | 20 = without hair |
| iii) | 90 = other |
| iv) | 00 = not applicable |

b. color

| | |
|---|---|
| i) | 10 = black |
| ii) | 20 = blonde |
| iii) | 30 = blue |
| iv) | 90 = other |
| v) | 00 = not applicable |

c. gender

| | |
|---|---|
| i) | 10 = male |
| ii) | 20 = female |
| iii) | 00 = not applicable |

d. clothing

| | |
|---|---|
| i) | 10 = dressed |
| ii) | 20 = undressed |
| iii) | 00 = not applicable |

e. accessories

| | |
|---|---|
| i) | 10 = with accessories |
| ii) | 20 = without accessories |
| iii) | 00 = other |

3. MUT™ Codification

It is understood that this section depicts the mechanism of creating MUT™ code based on a 2-digit structure and, following some improvement, that structure is now based on a 3-digit number pair past the first 6 digits as explained why and how previously. However, the concept stays the same and the rule stays applicable in the same way. Also, this section explains the first fat method to generate the global MUT™ code base. A second method using a more dynamic way will be explained after this one. Consolidating the categories and values yields a global MUT™ code format. Continuing with the previous example, a global MUT™ code format is defined that includes the codified categories and values from the U.S., Canada, and Mexico (and any other countries using the HS code 506070). If other countries defined different categories, those too would be included in the global MUT™ code format, thereby allowing a set of global MUT™ codes to be defined having substantially global applicability. In this example, the global MUT™ code format for the HS code 506070 corresponding to toys made of plastic, doll may be defined to include the categories of head attribute, color, gender, clothing and accessories, as follows:

| DESCRIPTION | DIGITS |
|---|---|
| base HS code | 1-6 |
| Head Attribute | 7-8 |
| Color | 9-10 |
| Gender | 11-12 |
| Clothing | 13-14 |
| Accessories | 15-16 |

Using the global MUT™ code format, for each base HS code, a table of local MUT™ codes is defined for each country. Each local MUT™ code in the table of local MUT™ codes adheres to the format of the global MUT™ code, so includes the base HS code plus different valid combinations of category values, but only for the categories applicable for that country. If a country does not use a category in the global MUT™ code format, the values of the category in the table of local MUT™ codes for that country are “not applicable”. This process is accomplished for each HS code and for each country, so that for each base HS code, a table of local MUT™ codes with applicable categories and values exists for each country that uses the HS.

Using the global MUT™ code format, sets of local MUT™ codes for U.S., Canada, and Mexico, in this example, are defined, as depicted in Tables 10A, 10B, and 10C.

TABLE 10A
U.S. Local MUT ™ Codes (Sample)

| | Head | | | | | |
|---|---|---|---|---|---|---|
| United States | Attribute | Color | Gender | Clothing | Accessories | Resulting Local MUT ™ |
| 5060701010 | 10 | 20 | 00 | 00 | 00 | 5060701020000000 |
| 5060701020 | 10 | 10 | 00 | 00 | 00 | 5060701010000000 |
| 5060701090 | 10 | 90 | 00 | 00 | 00 | 5060701090000000 |
| 5060702000 | 20 | 00 | 00 | 00 | 00 | 5060702000000000 |

Note that in Table 10A, the values for categories gender, clothing and accessories are always 00 (i.e., not applicable), since in Table 9A the US did not define these categories. The local MUT™ codes for Canada may be defined as follows:

TABLE 10B
Canadian Local MUT ™ Codes (sample)

| | Head | | | | | Resulting Local |
|---|---|---|---|---|---|---|
| Canada | Attribute | Color | Gender | Clothing | Accessories | MUT ™ |
| 506070101010 | 00 | 00 | 10 | 10 | 10 | 5060700000101010 |
| 506070101020 | 00 | 00 | 10 | 10 | 20 | 5060700000101020 |
| 506070102000 | 00 | 00 | 10 | 20 | 00 | 5060700000102000 |
| 506070201010 | 00 | 00 | 20 | 10 | 10 | 5060700000201010 |
| 506070201020 | 00 | 00 | 20 | 10 | 20 | 5060700000201020 |
| 506070202000 | 00 | 00 | 20 | 20 | 00 | 5060700000202000 |

Note that in Table 10B, the values for categories head attribute and color are always 00 (i.e., not applicable), since in Table 9B Canada did not define these categories. The local MUT™ codes for Mexico may be defined as follows:

TABLE 10C
Mexican Local MUT ™ Codes (sample)

| | Head | | | | | Resulting Local |
|---|---|---|---|---|---|---|
| Mexico | Attribute | Color | Gender | Clothing | Accessories | MUT ™ |
| 506070101010 | 10 | 10 | 10 | 00 | 00 | 5060701010100000 |
| 506070101090 | 10 | 90 | 10 | 00 | 00 | 5060701090100000 |
| 506070109000 | 90 | 00 | 10 | 00 | 00 | 5060709000100000 |
| 506070201010 | 10 | 10 | 20 | 00 | 00 | 5060701010200000 |
| 506070201020 | 10 | 20 | 20 | 00 | 00 | 5060701020200000 |
| 506070201030 | 10 | 30 | 20 | 00 | 00 | 5060701030200000 |
| 506070201090 | 10 | 90 | 20 | 00 | 00 | 5060701090200000 |
| 506070209000 | 90 | 00 | 20 | 00 | 00 | 5060709000200000 |

Note that in Table 10C, the values for categories clothing and accessories are always 00 (i.e, not applicable), since in Table 9C Mexico did not define these categories. Table 10A through Table 10C may actually be combined in a single table for the base HS code 506070, as is shown below.

4. MUT™ Validation

A result of the validation is the generation of the Master MUT™ Table comprised of all validated global MUT™ codes, as well as a “Country Code Table” for each country having its HS based codes entered into the MUT™ system. Each Country Code Table is comprised of a listing of all valid local MUT™ codes for the country. Individual local MUT™ codes from the Country Code Tables are associated with the corresponding, validated global MUT™ code from the Master MUT™ Table. These tables, which may be stored in a MUT™ database system, are made available to users for product coding and classification.

Adhering to the global MUT™ code format, a set of global MUT™ codes is defined for a given base HS code. Each global MUT™ code in the set includes the base HS code plus different combinations of valid values for valid categories. Values for each category of a global MUT™ code are from the values used by each country for the category, to the maximum extent possible. Values that are not considered include values eliminated due to conflict with value definitions by other countries and values that were not defined by any country. That is, if for the category color the values black=10, blonde=20, and blue=30 are defined, but a value of brown=40 has not been defined by any country, then brown=40 would not be a valid value for the category color. Any color other than the three defined colors would fall into value 90=other.

Each global MUT™ code is validated against the local MUT™ codes of each country having the same base HS code. A valid global MUT™ code is one for which at least one country has at least one local MUT™ code having category values that do not conflict with the global MUT™ code category values, as will be described in detail below. If there is more than one local MUT™ code from the same country that is valid for the global MUT™ code, a best local MUT™ code from that country is determined. For a given country, a best local MUT™ code is determined as function of the highest correlation among category values between the global MUT™ code and the valid local MUT™ codes. If a local MUT™ code does not have a corresponding global MUT™ code, an error message results if that local MUT™ code is used. If a global MUT™ code can not be validated against at least one local MUT™ code then that global MUT™ code is not included in the Master MUT™ Table and an error message results if that global MUT™ code is used.

Validation is attempted for every global MUT™ code, which means every valid combination of category values is assessed against local MUT™ codes of all countries. Similarly, every local MUT™ code is evaluated to determine if it corresponds to a global MUT™ code. When a new country begins to use the HS, it may adopt the global MUT™ codes for its products, or the country may at least define its codes to be consistent with the global MUT™ codes. In any case, when the new country's HS based product codes are added to the MUT™ system, the MUT™ system is used to generate local MUT™ codes and a Country Code Table for that country, comprised of its valid local MUT™ codes.

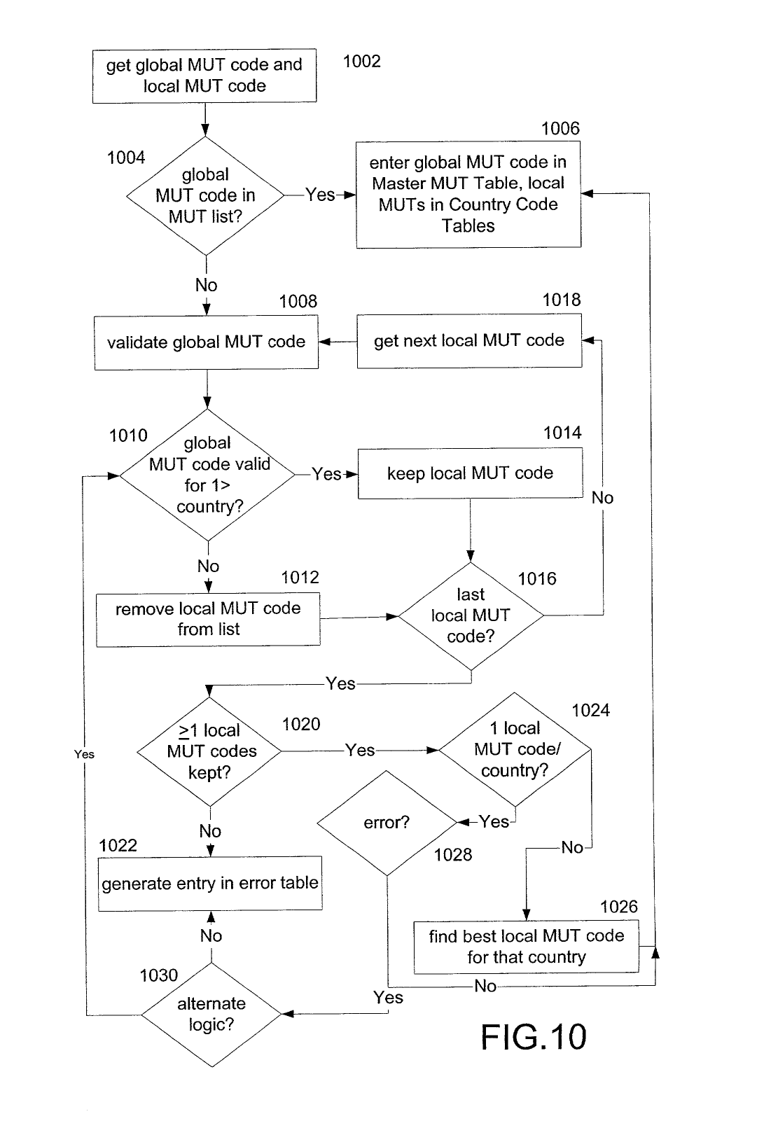

The process of validation may be appreciated with respect to the flow chart 1000 of FIG. 10. A table or list of all local MUT™ codes for all countries for a given base HS code can be generated. For example, Tables 10A through 10C above can be combined into a MUT™ table as follows:

TABLE 11
MUT ™ Table

| Country | Local HS Code | Local MUT ™ Code |
|---|---|---|
| US | 5060701010 | 5060701020000000 |
| US | 5060701020 | 5060701010000000 |
| US | 5060701090 | 5060701090000000 |
| US | 5060702000 | 5060702000000000 |
| CA | 506070101010 | 5060700000101010 |
| CA | 506070101020 | 5060700000101020 |
| CA | 506070102000 | 5060700000102000 |
| CA | 506070201010 | 5060700000201010 |
| CA | 506070201020 | 5060700000201020 |
| CA | 506070202000 | 5060700000202000 |
| MX | 506070101010 | 5060701010100000 |
| MX | 506070101090 | 5060701090100000 |
| MX | 506070109000 | 5060709000100000 |
| MX | 506070201010 | 5060701010200000 |
| MX | 506070201020 | 5060701020200000 |
| MX | 506070201030 | 5060701030200000 |
| MX | 506070201090 | 5060701090200000 |
| MX | 506070209000 | 5060709000200000 |

A global MUT™ code is selected for validation, in step 1002, and a determination is made regarding whether or not the selected global MUT™ code exists in the MUT™ Table in step 1004. For example, assume the global MUT™ code selected was “5060700000101010”. This code does exist in Table 11 (for Canada), so this global MUT™ code would be placed in the Master MUT™ Table and associated with the corresponding local MUT™ code(s) in Table 11, in step 1006. Since the global MUT™ code only matches the entry from Canada, the global MUT™ code would only be associated with that local MUT™ code in the Country Code Table for Canada.

If, in step 1004, the global MUT™ code did not match a local MUT™ code in Table 11, the global MUT™ code must be validated for all countries, category by category, which is initiated in step 1008. Preferably, the validation takes into consideration that the first 6 digits (i.e., the base HS code) are a common representation between global MUT™ code and local MUT™ codes. Consequently, the first three digit pairs need not be taken into account, but each subsequent digit pair represents a category used in validation.

Assume the global MUT™ code of 5060701020101010 is to be validated in step 1008. The global MUT™ code is compared against each local MUT™ code from Table 11 and, in step 1010, a determination is made of whether a match is found, on a category by category basis. At first, it is assumed that the global MUT™ code is valid, but if one condition is found indicating that a match is not found the validation process is stopped with respect to the local MUT™ code. The following rules are applied when comparing the global MUT™ code to a local MUT™ code from Table 11:

(1) If the value of the category to be validated from the global MUT™ code is 00, the country's local MUT™ code value for that category must also be 00;

(2) If the value of the category to be validated from the global MUT™ code is 90, the country MUT™ code value must be 90 or 00; and

(3) If the value of the category to be validated from the global MUT™ code is a value having a specific meaning (e.g., 10=black), the country's local MUT™ Code value must be the same value (e.g., 10), 90 or 00.

Returning to our example, for this validation, the first 6 digits representing the HS code (i.e., 506070) are not analyzed, but the remaining 2 digit pairs for each category (i.e., 10, 20, 00, 00, and 00, respectively) are analyzed. The following table indicates the comparison of the global MUT™ code to all local MUT™ codes for each country in the example.

TABLE 12A
Validation of Global MUT ™

| GM | 506070 | 10 | 20 | 10 | 10 | 10 | Global MUT ™ code to be validated |
|---|---|---|---|---|---|---|---|
| US | 506070 | 10 | 20 | 00 | 00 | 00 | Found a possible match |
| US | 506070 | 10 | 10 | 00 | 00 | 00 | Does not match logic because 10 < > 20, 90 or 00 |
| US | 506070 | 10 | 90 | 00 | 00 | 00 | Found a possible match |
| US | 506070 | 20 | 00 | 00 | 00 | 00 | Does not match logic because 20 < > 10, 90 or 00 |
| CA | 506070 | 00 | 00 | 10 | 10 | 10 | Found a possible match |
| CA | 506070 | 00 | 00 | 10 | 10 | 20 | Does not match logic because 20 < > 10, 90 or 00 |
| CA | 506070 | 00 | 00 | 10 | 20 | 00 | Does not match logic because 20 < > 10, 90 or 00 |
| CA | 506070 | 00 | 00 | 20 | 10 | 10 | Does not match logic because 20 < > 10, 90 or 00 |
| CA | 506070 | 00 | 00 | 20 | 10 | 20 | Does not match logic because 20 < > 10, 90 or 00 |
| CA | 506070 | 00 | 00 | 20 | 20 | 00 | Does not match logic because 20 < > 10, 90 or 00 |
| MX | 506070 | 10 | 10 | 10 | 00 | 00 | Does not match logic because 20 < > 10, 90 or 00 |
| MX | 506070 | 10 | 90 | 10 | 00 | 00 | Found a possible match |
| MX | 506070 | 90 | 00 | 10 | 00 | 00 | Found a possible match |
| MX | 506070 | 10 | 10 | 20 | 00 | 00 | No match, 10 20, 90 or 00 and 20 10, 90 or 00 |
| MX | 506070 | 10 | 20 | 20 | 00 | 00 | Does not match logic because 20 < > 10, 90 or 00 |
| MX | 506070 | 10 | 30 | 20 | 00 | 00 | No match,30 20, 90 or 00 and 20 10, 90 or 00 |
| MX | 506070 | 10 | 90 | 20 | 00 | 00 | Does not match logic because 20 < > 10, 90 or 00 |
| MX | 506070 | 90 | 00 | 20 | 00 | 00 | Does not match logic because 20 < > 10, 90 or 00 |

From Table 12A, a determination is made as to whether the global MUT™ code is valid for each local MUT™ code from each country, in step 1008. If, applying the above logic, there is no match for a local MUT™ code, as indicated in Table 12A for US 5060701010000000, that local MUT™ code is not valid, so is removed, in step 1012. If there is a match, the local MUT™ code is maintained in the table, in step 1014. A check is performed, in step 1016, to determine if the local MUT™ being evaluated is the last local MUT™ code from the table. If not, the next local MUT™ code is used and the process returns to step 1018, where the next local MUT™ code is obtained and used for validation. The following table is produced, of only valid local MUT™ codes:

TABLE 12B
Valid Local MUT ™ Codes

| GM | 506070 | 10 | 20 | 10 | 10 | 10 | Global MUT ™code to be validated |
|---|---|---|---|---|---|---|---|
| US | 506070 | 10 | 20 | 00 | 00 | 00 | Found a possible match |
| US | 506070 | 10 | 90 | 00 | 00 | 00 | Found a possible match |
| CA | 506070 | 00 | 00 | 10 | 10 | 10 | Found a possible match |
| MX | 506070 | 10 | 90 | 10 | 00 | 00 | Found a possible match |
| MX | 506070 | 90 | 00 | 10 | 00 | 00 | Found a possible match |

If the last local MUT™ code used in evaluation is the last local MUT™ code in Table 12A, the process continues to step 1020 where it is determined whether there were any valid local MUT™ codes in Table 12B. If there are no valid local MUT™ codes, in step 1020, an error message is generated in an error table, in step 1022, which will be accessed if the global MUT™ code (having no valid local MUT™ code associations) is used. Assuming there are entries in the valid local MUT™ code table (as is the case in Table 12B), the process continues to step 1024, where it is determined whether there are more than one valid local MUT™ codes for a given country, since only one valid local MUT™ is allowed for each country in the preferred in embodiment. If there is more than one valid local MUT™ code for a given country, the process continues to step 1026.

In step 1026, a determination is made as to which valid local MUT™ code for a country having multiple valid local MUT™ codes is the “best” match. The best local MUT™ code for a country is chosen by the following logic:

(1) Select only the local MUT™ code(s) that have the most number of matching value digit pairs that are not 00 and not 90;

(2) From those let after (1), select only the MUT™ code(s) that have the lowest number of 90.

From our example the following table is produced:

TABLE 12C
Evaluation of Valid Local MUT ™ Codes

| GM | 506070 | 10 | 20 | 10 | 10 | 10 | Global MUT ™ code to be validated |
|---|---|---|---|---|---|---|---|
| US | 506070 | 10 | 20 | 00 | 00 | 00 | Found the best match (#90 = 0 and #00 = 3) |
| US | 506070 | 10 | 90 | 00 | 00 | 00 | #90 = 1 and #00 = 3 |
| CA | 506070 | 00 | 00 | 10 | 10 | 10 | Found the best match |
| MX | 506070 | 10 | 90 | 10 | 00 | 00 | Found the best match (#90 = 1 and #00 = 2) |
| MX | 506070 | 90 | 00 | 10 | 00 | 00 | #90 = 1 and #00 = 3 |

This process yields the following result:

TABLE 12D
Best Valid Local MUT ™ Codes

| | | |
|---|---|---|
| GM | 5060701020101010 | Global MUT ™ code to be validated |
| US | 5060701020000000 | The best match possible for U.S. |
| CA | 5060700000101010 | The best match possible for Canada |
| MX | 5060701090100000 | The best match possible for Mexico |

In step 1006, the global MUT™ code is inserted into the Master MUT™ Table and the best valid local MUT™ codes from Table 12D are inserted into the MUT™ Country Code Table for each country. The local MUT™ codes are used again when the next global MUT™ code having the same base HS code is validated.

If, in step 1024, there was not more than one valid local MUT™ left (e.g., in Table 12B) for a given country, then the process continues to step 1028 to determine if errors exist. If, according to the determination in step 1028, errors do not exist, the process continues to step 1006, where the global MUT™ code is inserted into the Master MUT™ Table and the valid local MUT™ from each country is inserted into the corresponding MUT™ Country Code Table.

Errors, in step 1028, may occur when a match can not be found for a global MUT™ code or for a local MUT™ code during the validation process described above, for example. Typically, errors are either data errors or logic errors. In either case, alternate logic may be employed, in step 1030, such as human inspection of an error message, automated analysis, or some combination thereof to resolve the error or to attempt validation by a different means. Using the alternate logic, in step 1030, the process of validating the global MUTE code is restarted, and the process returns to step 1008. There maybe multiple forms of alternate logic, so the process may recycle at least once for each type. If the alternate logic fails to clear the error, the process continues to step 1022, where the error is logged in a MUT™ error message table.

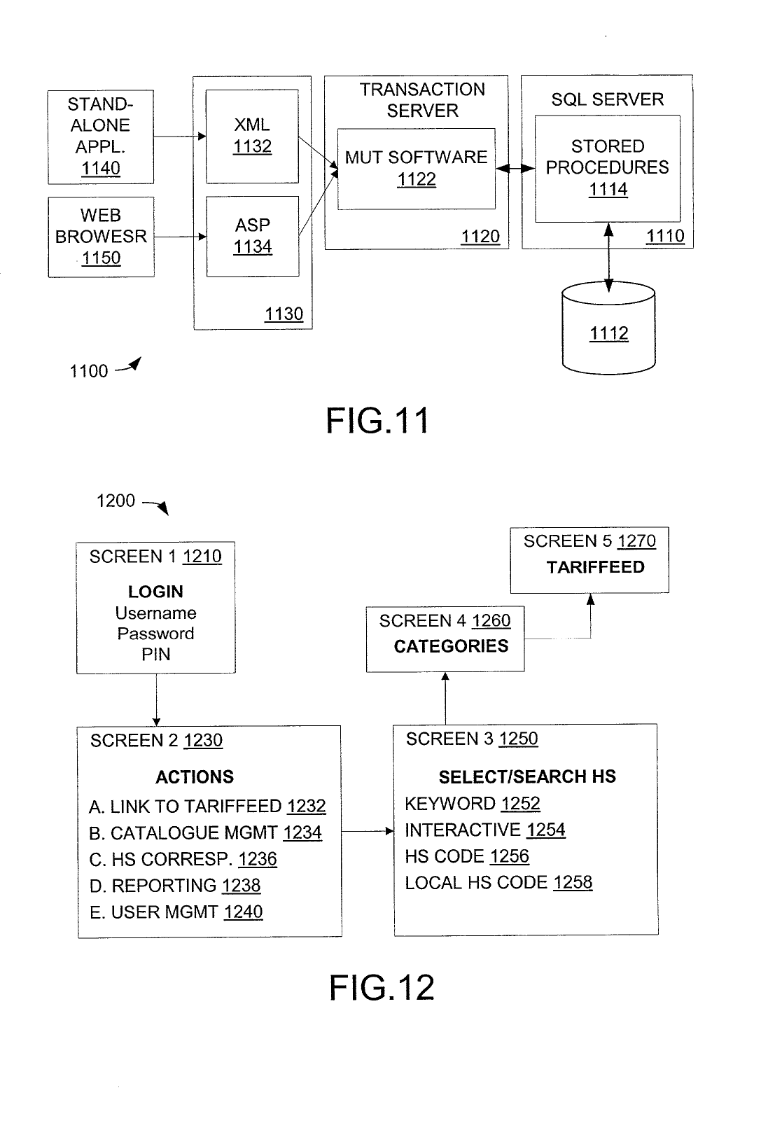

A basic architecture 1100 for the MUT™ system is shown in FIG. 11. The Master MUT™ Table, Country Code Tables, and user product databases may be stored in a storage device 1112, accessible via a SQL server 1110, in accordance with a set of stored procedures 1114, as is typical in the art. A transaction server 1120, such as that provided by Microsoft, Inc. of Washington, may be used to host components that provide the full range of MUT™ functions described herein, referred to as MUT™ software 1122. The MUT™ software 1122 accesses the database server 1110 in response to user requests received by a front-end interface server 1130. The MUT™ system may be configured to be accessed by standalone applications 1140 and/or devices having Web browsers 1150 (or similar standardized interfaces). Standalone applications 1140 may be written in any standard languages and/or with standard tools, such as Visual Basic, C++, Microsoft Access, Delphi, or any other Windows™ (by Microsoft, Inc.) tool. Such applications 1140 may interface with a XML interface 1132 on the transaction server. The Web browsers may interact with a “ASP” application 1134 in a known manner (e.g., using XML), which returns Web pages and data in response to user generated requests.

5. 3-Bit Representations

In other embodiments, 3-bit representations of categories may be used, rather than 2-bit representations. As will be appreciated by those skilled in the art, 3-bit representations allow a greater number of distinctions to made within a category. In the preferred form, when 3-bits are used, bits 900-999 are reserved, allowing flexibility in the MUT system. Appendix J provides a guide to expanding from the 2-bit representations to 3-bit representations. Appendix K provides a guide to validating the 3-bit representations.

Part V—MUT™ System User Product Classification

With the Master MUT™ Table and Country Code Tables created a user, such as a retailer, manufacturer, or distributor, as examples, may enter and classify its products offerings in a product database, or it may edit or delete existing products in the product database, using the architecture I1100 of FIG. 11. Classification is performed in accordance with the global MUT™ codes, from the Master MUT™ Table, by selecting the proper HS code and defining the appropriate extensions. To facilitate such entry and classification, the MUT™ system may include a multilingual user interface as a front end to the MUT™ functionality. In the preferred form, the MUT™ system interface is a Web browser interface. In other embodiments, the MUT™ system may be a backend system to an e-commerce Web site or may be a subsystem of the real-time tariff and import data system.

Using the MUT™ system, the user can classify all of its SKUs or product references for all countries represented in the MUT™ system and build its own product database of MUT™ product codes. Any product's HS code may be retrieved for a given country or for one or all represented countries. The concordance between a HS code and its corresponding HS based code in one or more countries can be determined. And, in cooperation with the real-time tariff and import data system, accurate total landed cost calculations (or other real-time tariff and import data system calculations) can be made using the MUT™ product codes. The MUT™ system may be used to store information relating to transactions performed and generate related reports, preferably with reference to the user defined SKU or other product reference. Users may selectively share one or more MUT™ product codes with affiliates, partners, customers and so forth. Such sharing may be accomplished by providing access or links to the user's product database.

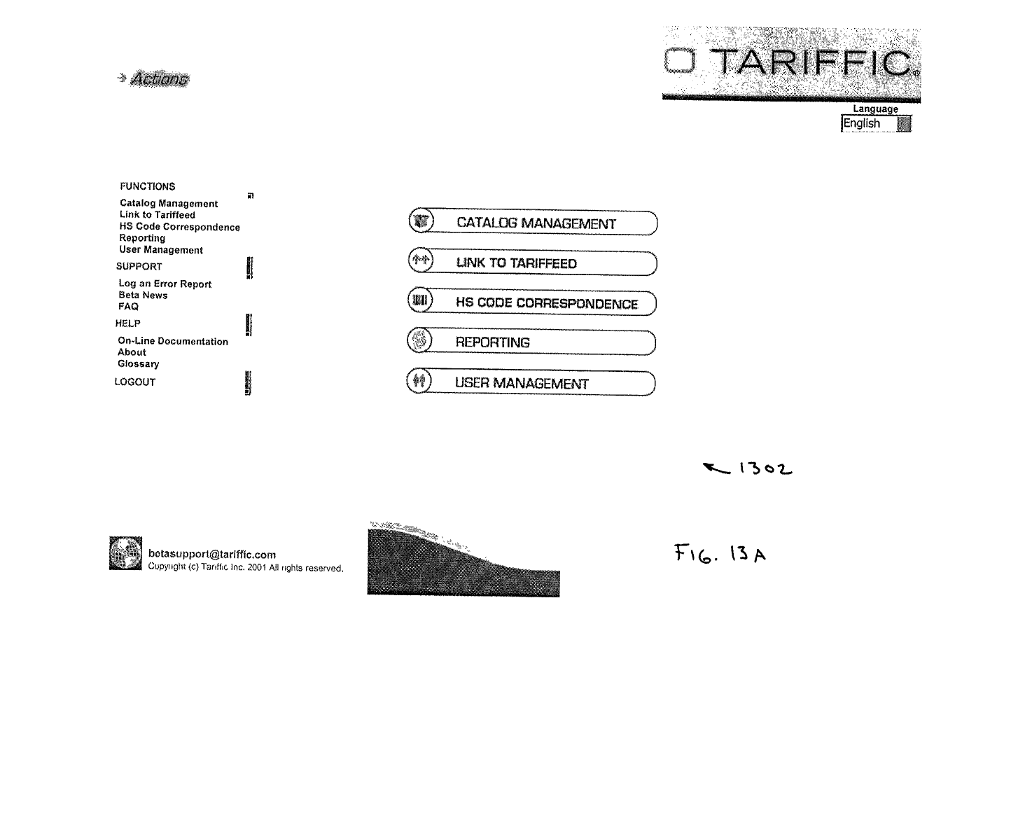

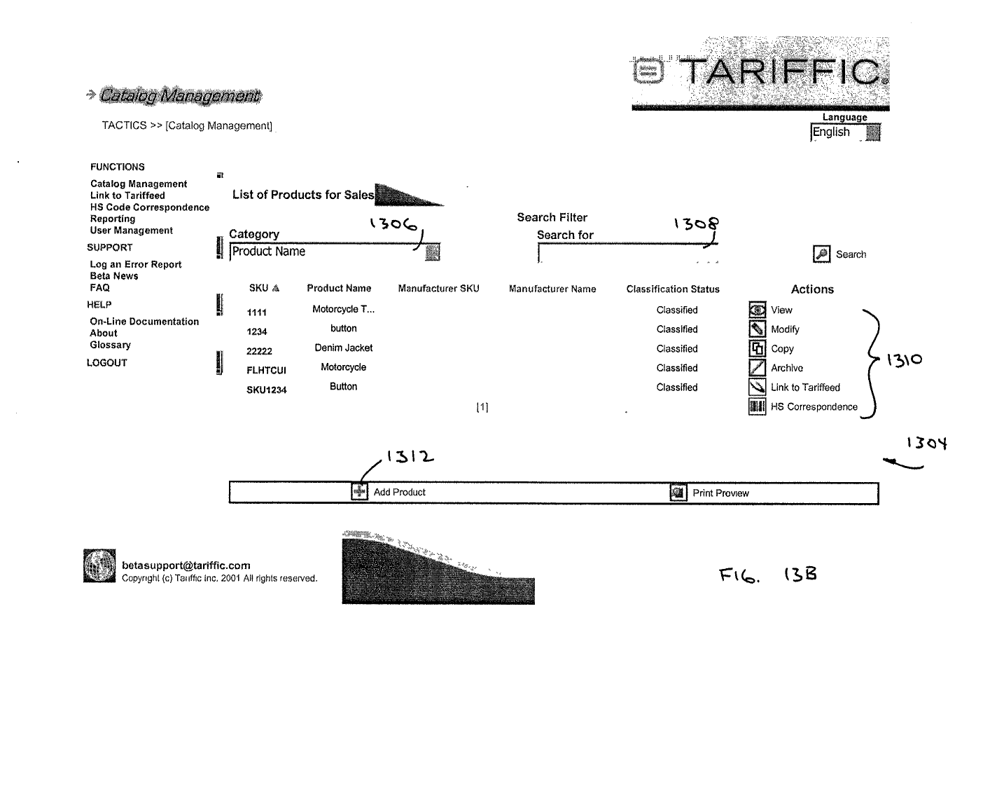

FIG. 12 is a top level block diagram 1200 depicting the topology of user screens for interacting with the MUT™ system for entering, classifying and validating products and performing related activities. In the preferred form, many users may establish and maintain accounts (and product databases) using the MUT™ system. Accordingly, a login screen 1210 may be first presented to the user. Assuming successful login, an Actions screen 1220 provides various options to the user to perform certain predefined actions, such as linking to the real-time tariff and import data system (such as Tariffeed™ by Tariffic, Inc.). As an example, a Link to Tarifeed™ action 1232 maybe provided that allows a user to obtain a total landed cost calculations (or other previously described calculations) for a given product. A Catalogue Management action 1234 may be provided that facilitates product classification and editing. An HS Code Correspondence action 1236 may be provided that allows a user to determine local MUT™ codes for each country in the system for an entered or selected HS code or product. A Reporting action 1238 may be provided that allows reporting on various transactions. And, a User Management action 1240 that facilitates general account administration and maintenance for each user.

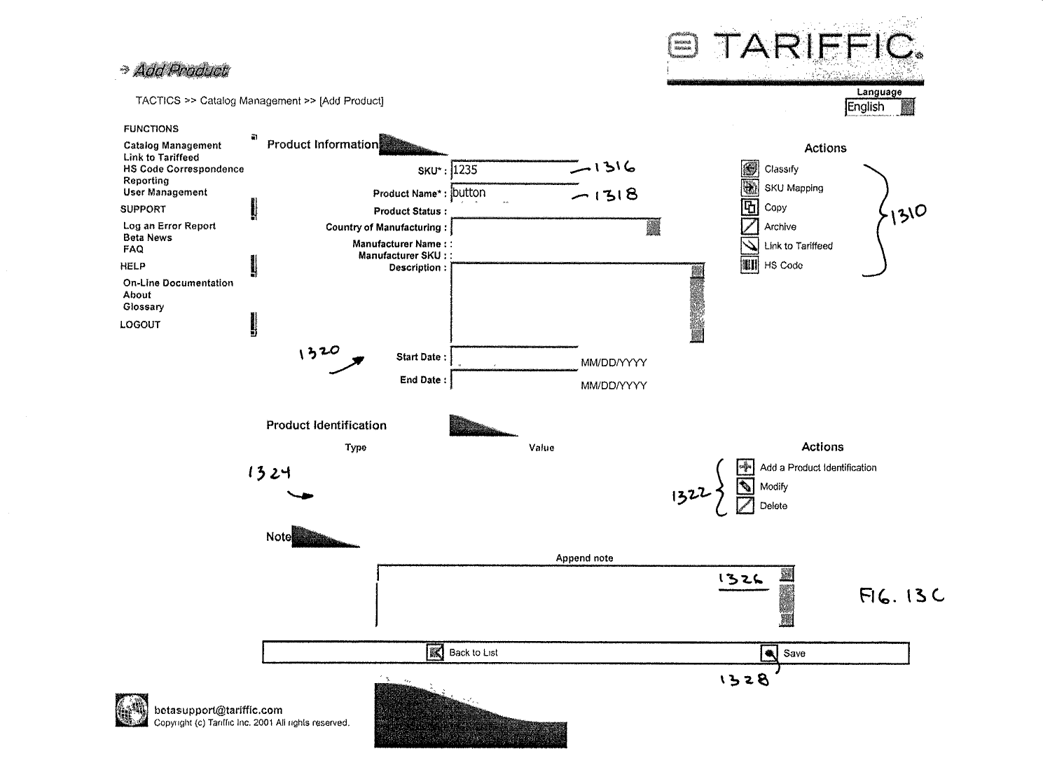

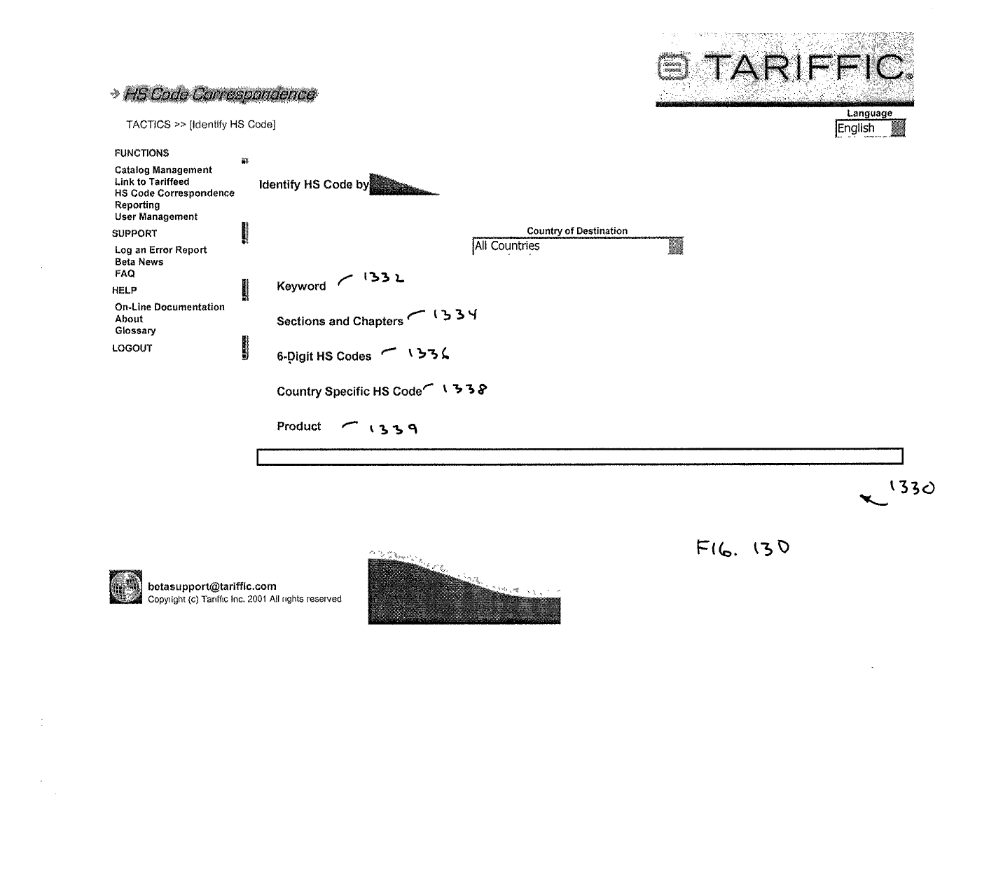

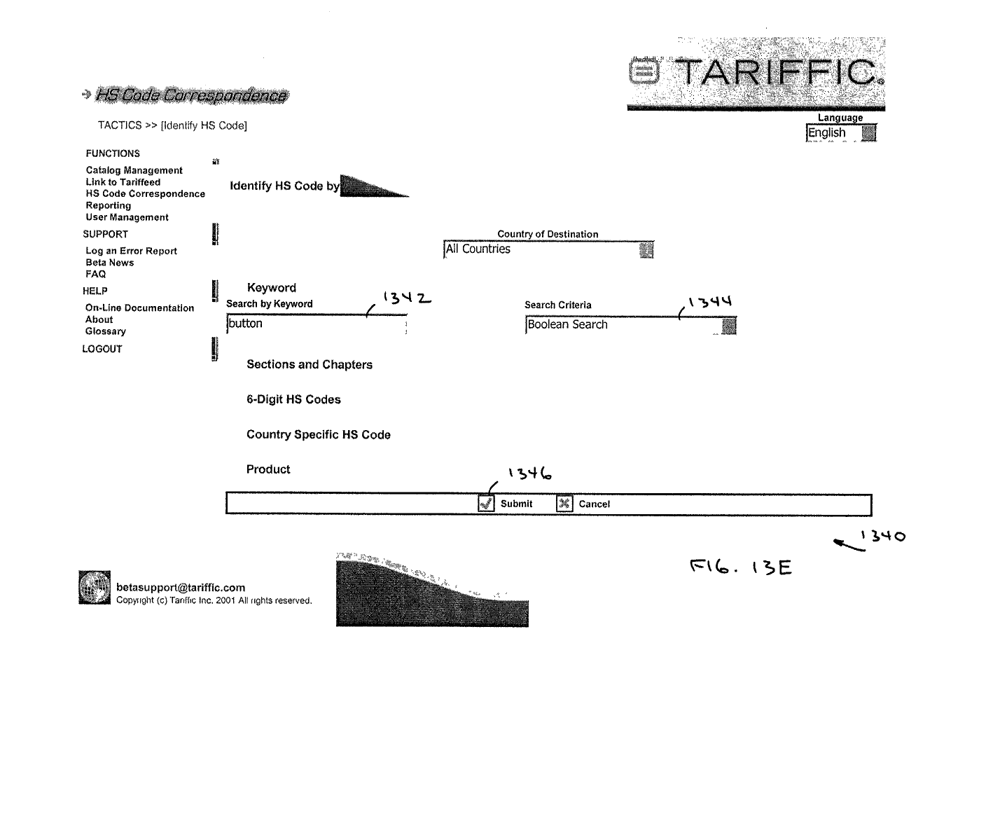

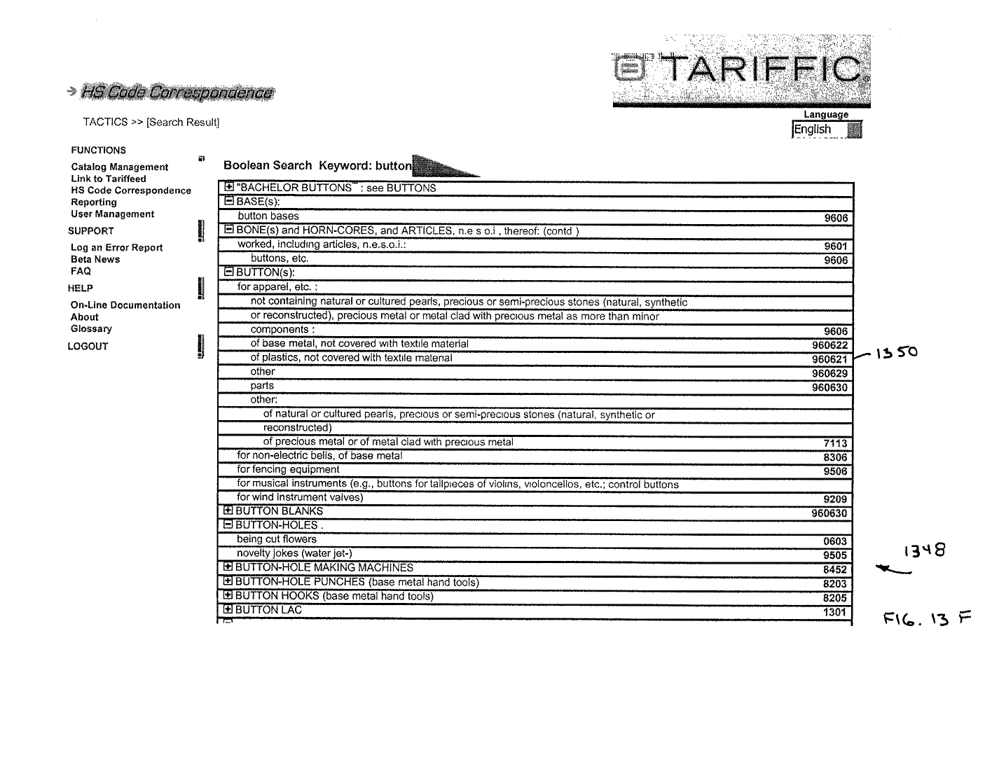

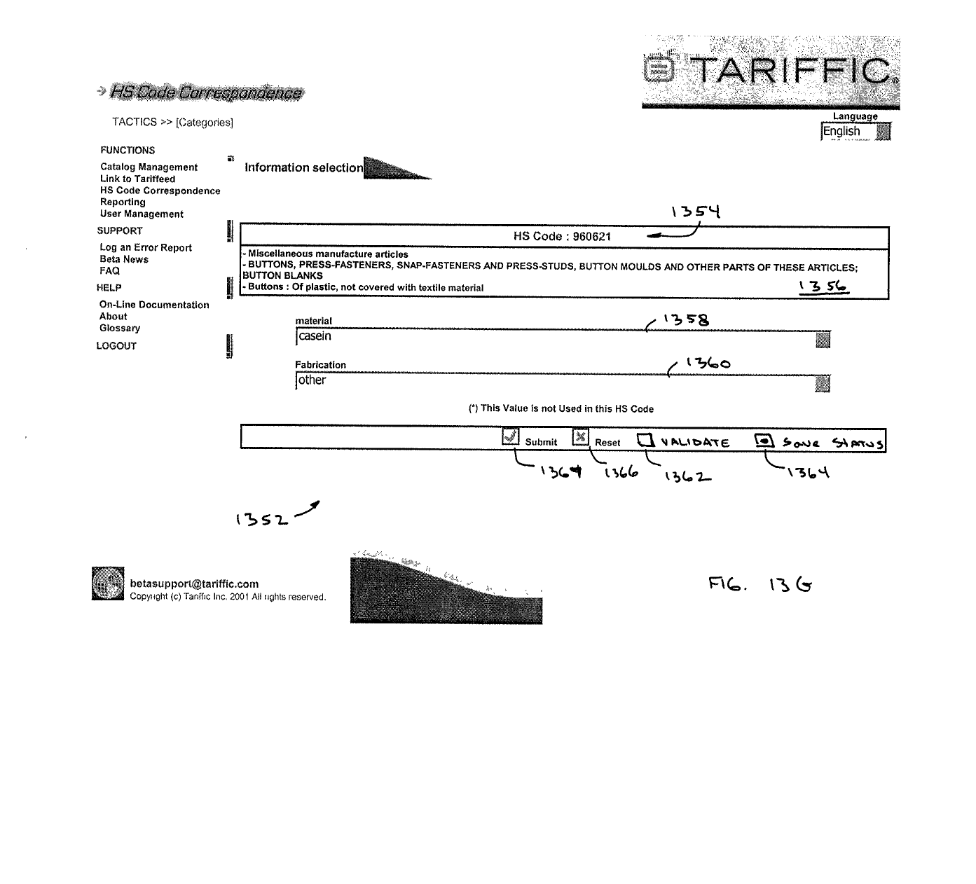

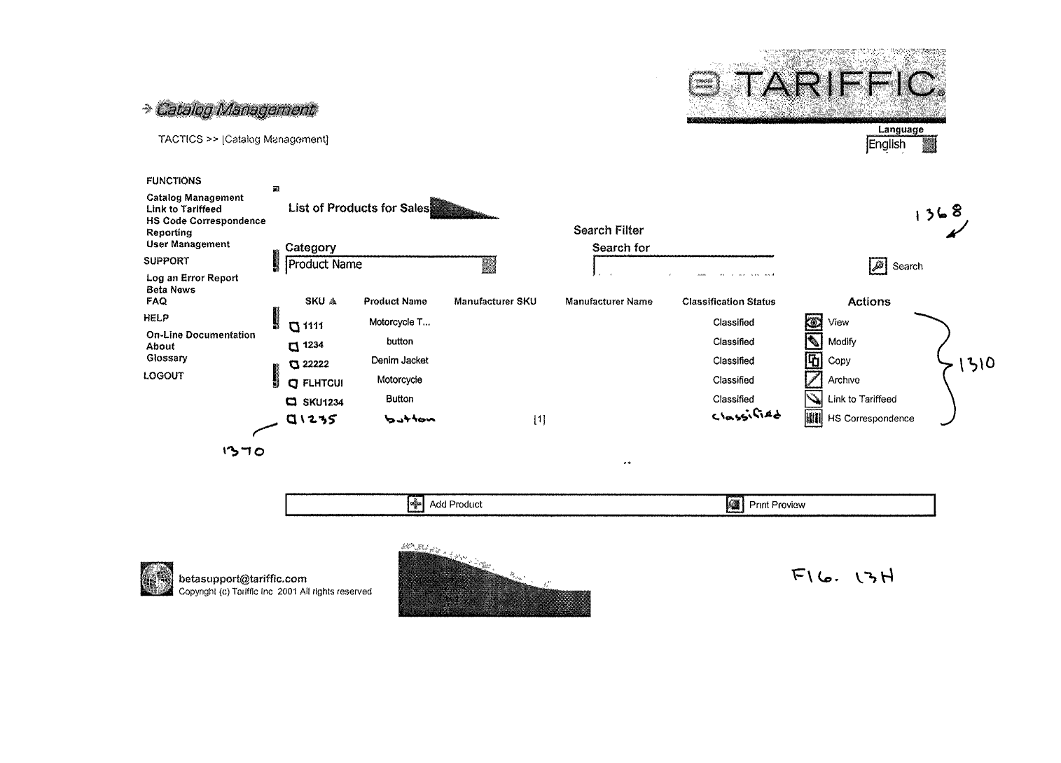

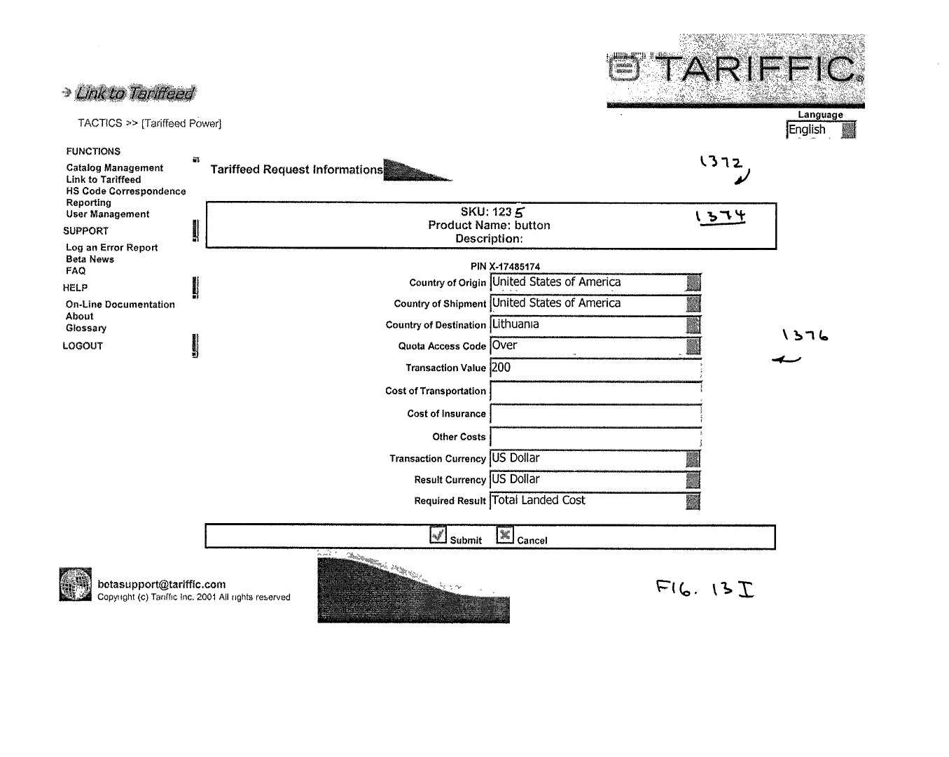

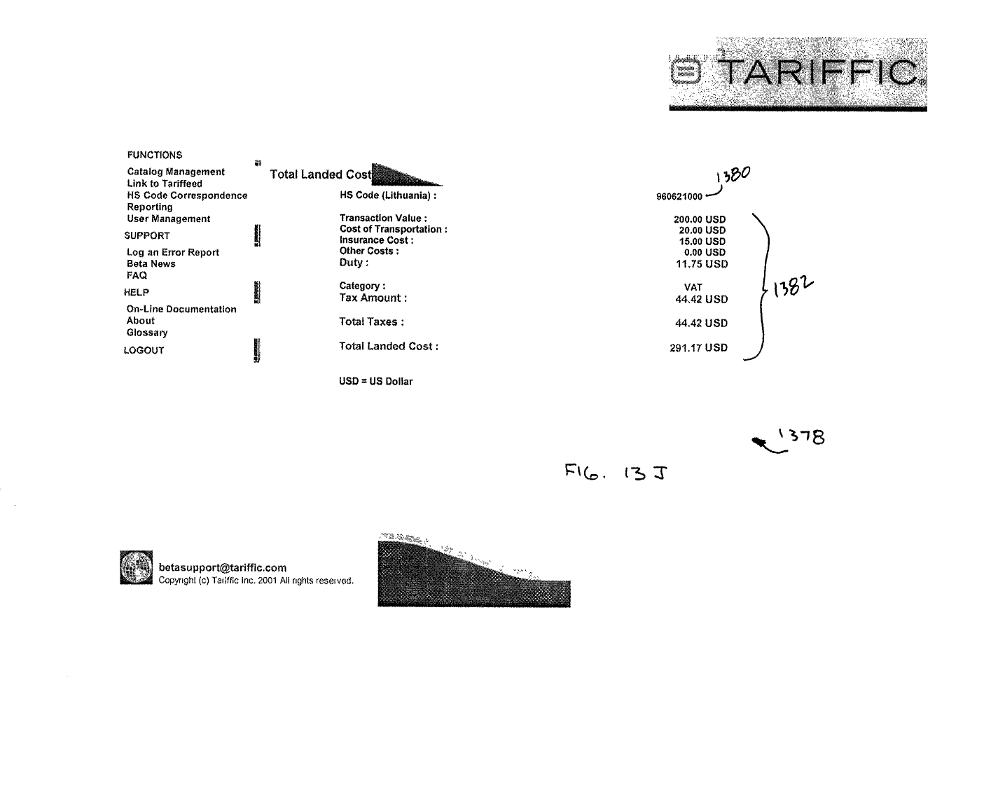

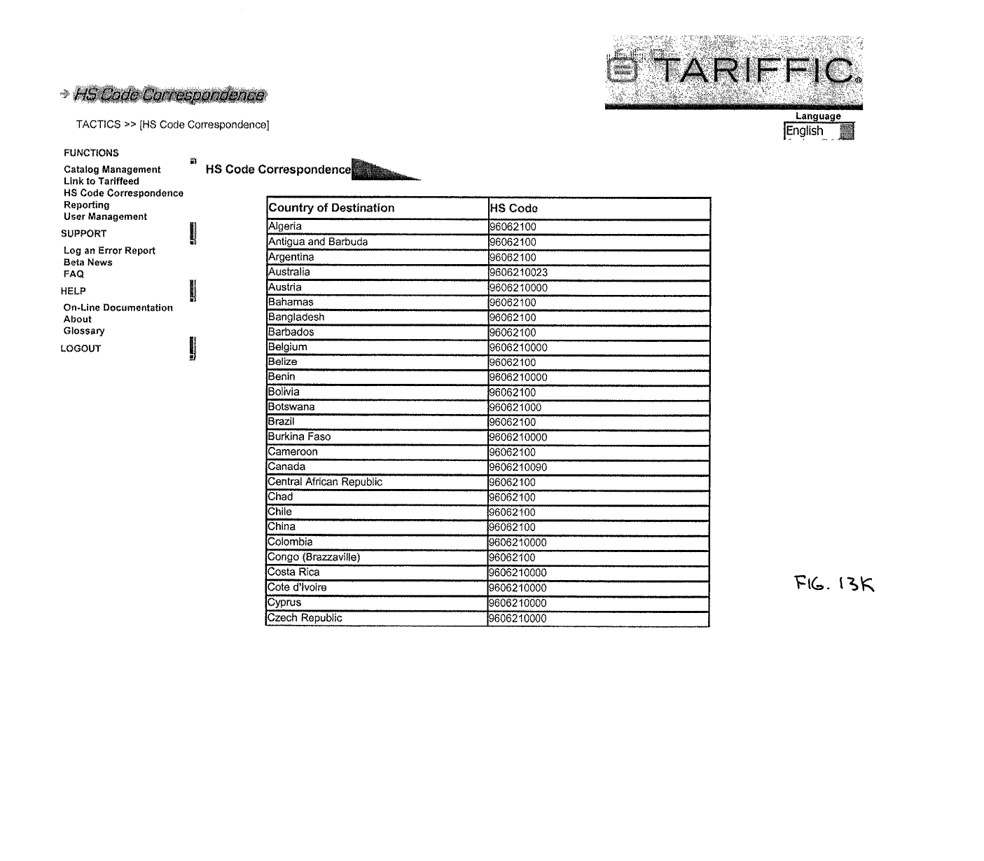

Selection of either of the Catalogue Management action 1234 or HS Correspondence action 1236, transfers the user to a screen 1250 that provides various mechanisms to obtain or enter an HS code for a product. The mechanisms may include one or more of search by Keyword 1252, Interactive (or Sections and Chapters) search 1254, search by HS code 1256, and/or search by local Country Specific HS Code 1258. Once an HS code has been selected for classification of a product, a user may define category values using a Categories screen 1260. To verify new or edited product classifications, a link to the real-time tariff and import data system, for which an associated screen 1270 is provided. These actions are described with respect FIG. 13A through FIG. 13K.

In FIG. 13A, an Actions screen 1302 provides user selectable actions (1) Catalogue Management 1232; (2) Link to Tarifeed™ (for example) 1234; (3) HS Code Correspondence 1236; (4) Reporting 1238; and (5) User Management 1240, as previously described. Selection of the Catalogue Management 1232 action, leads to screen 1304 in FIG. 13B. Catalogue Management screen 1304 includes a category field 1306 that allows input or selection of an existing product category (e.g., product name ) and a corresponding search field 1308 that allows entry of a term to be searched with respect to the category of field 1306. A set of graphical user interface mechanisms 1310 are provided to operate on an existing product having MUT™ products codes defined in the user's product database. Mechanisms 1310 include view, copy, modify (or edit), archive (to store a MUT™ product code), Link to Tarifeed™ and HS Code Correspondence, as previously described. Additionally, an Add Product mechanism 1312 is provide to facilitate entry and classification of a product by a user.

FIG. 13C shows screen 1314 is presented in response to selection of the Add Product mechanism 1312. The user may define a product by entering product information, such as an SKU (e.g., “1234”) into field 1316 and a product name (e.g., “button”) in field 1318. Other fields may also be provided to allow entry of additional product information. As an example, a “Start Date” field and an “End Date” field may be provided when the information is to be valid or available for a select duration of time. In addition to mechanisms 1310, mechanisms 1322 may be provided to add, modify or delete products identified in field 1324. A field to append a note is 1326 to the classified product (in the user's product database) may be provided. A “save” mechanism 1328 is also provided for storing new or modified products.

Choosing the “Classify” mechanism from the screen of FIG. 13C for the entered product information, causes screen 1330 to be presented. Screen 1330 provides the four selectable HS selection and input mechanisms previously described. The Keyword mechanism 1332 allows the user to search for one or more keywords or search terms that, for example, may be found in a description of an HS code. An interactive search mechanism 1334 allows the user to define or select a set of parameters (e.g., section, chapter, heading, and/or subheading), preferably from a group predefined parameters, related to an HS code or product and have returned a base HS code. The next mechanism, i.e., the 6-digit HS Codes mechanism 1336, allows the user to enter a base HS code, which is typically 6 digits, if known. Another mechanism, i.e., the Country Specific HS Code mechanism 1338, allows the user to enter a valid local HS code for the product, if known. Using any of these mechanisms, with an HS code obtained the user can proceed to define extensions according to the corresponding global MUT™ code.

Selection of the Keyword mechanism 1332, for example, causes presentation of screen 1340 of FIG. 13E. The entered product name “button” (entered in FIG. 13A) appears in Search by Keyword field 1342, but may be edited if desired by the user. The user may also enter or select a search type (e.g., a boolean search) in Search Criteria field 1344. The search requirements may be submitted through selection of Submit mechanism 1346, which yields a list of selectable products 1348 that include the search terms (e.g., button), partially shown in FIG. 13F.

Selection of the HS code 960621 1350 (corresponding to “BUTTONS”) from the list of FIG. 13F causes presentation of screen 1352 of FIG. 13G. Screen 1352 includes the HS Code 1354 (or base HS code) associated with the selection; here the HS Code is 960621. A description of products having the HS code is shown in field 1356. With the base HS code provided to the user, the user defines category values, on a category by category basis, as allowed by the corresponding global MUT™ code for the given base HS code. As shown in FIG. 13G, the categories for the HS code, according to the corresponding MUT™ code, are Material 1358 and Fabrication 1360. The values may be provided by drop down menus of only valid values, including the value “other” and “n/a” (i.e., not applicable). In FIG. 13G field 1358 has the value “casein” and field 1360 has the value “other”. Thereafter, the defined and classified product can be validated 1362, saved 1364, and/or cancelled 1366.

FIG. 13H provides a screen 1368 that is substantially the same as FIG. 13B, but shows the saved classified product 1370. That is, screen 1368 provides mechanisms previously described for searching an existing product and/or adding and classifying a new product. Validation of newly entered product 1370 (i.e., SKU 1234 or SKU 1235) can be accomplished by linking to the real-time tariff and import data system, as is shown in FIG. 131. Screen 1372 of FIG. 131 displays the SKU, Product Name, and Description (if any) in Tariffeed™ Request Information field 1374. Entering typical transaction information in fields 1376, such as country of origin, country of shipment, country of destination, transaction value, transaction currency, result currency, and an output result definition (e.g., total landed cost) allows a Tariffeed™ output to be generated.

Submission of the request causes generation of the screen 1378 of FIG. 13J. The Total Landed Cost screen 1378 includes the local MUT™ code 1380 for the destination country (e.g., Lithuania), as well as various costs and values 1382, such as Transaction Value and calculated values of Cost of Transportation, Insurance Costs, Other Costs, Duty Costs, Tax Amounts, Total Taxes and Total Landed Cost (e.g., $291.17 U.S. Dollars (USD)). FIG. 13K shows an HS Code Correspondence screen 1384, which is a partial, representative list of country specific local MUT™ codes corresponding the user's defined product code.

Using the screens of FIG. 13A through FIG. 13K a user can manage all of its product databases in accordance with the global MUT™ codes of the Master MUT™ Table.

What is claimed is:

1. (Amended) A method of generating HS based universal tariff product global codes from a plurality of HS based country product codes for products, wherein each country product code includes a base HS code and may further include product code extentions, said method comprising:
A. selecting a first base HS code from a plurality of defined base HS codes;
B. selecting a country having one or more country codes that include said first base HS code and, for said country, selecting a complete set of country product codes that include said base first HS code and one or more a set of country defined Product code extensions;
C. extracting from said country defined product code extensions, a set of country specific defined categories and category values;
D. determining if said extracted country defined categories and category values are included in a superset of categories and category values related to said base HS code and, to the extent not included, including said extracted country defined is product code categories and category values into said superset of categories and category values;
E. repeating parts B through D for each country having country product codes that include said base first HS code and then defining a universal extension comprised of said superset of categories and category values;
F. combining said base HS code and said universal extension in a global code; and
G. repeating steps A through F for each base HS code.

2. (Amended) The method of claim 1, further comprising entering one or more of said country codes via wherein a Web browser interface is provided to facilitate entry of said country codes.

3. (New) The method of claim 1, wherein said base HS codes are represented with 6 digits and said extensions are comprised of categories represented with digit pairs.

4. (New) The method of claim 1, wherein said base HS codes are represented with 6 digits and said extensions are comprised of categories represented with three digits.

5. (New) The method of claim 1, wherein for each base HS code each category represents a product attribute and each category value for a given category represents a different set of attribute values.

6. (New) The method of claim 1, wherein substantially each category includes a category value of “not applicable”.

7. (New) The method of claim 1, wherein one or more of said categories includes a category value representing a plurality of product attribute values.

8. (New) The method of claim 1, further comprising:
H. generating, for a given country, a set of universal country codes, each of said universal country codes conforming to the global code for a given base HS code and utilizing category values defined for said given country with respect to said given base HS code.

9. (New) The method of claim 8, further comprising:
I. generating, for a given country, a universal country code table comprised of said set of universal country codes.

10. (New) The method of claim 1, further comprising:
H. generating a master universal tariff table comprising said global codes.

11. (New) The method of claim 1, further comprising:
H. entering a set of user and product information, including an identification of a user and a set of product identifications associated with said user;
I. generating, for each of said product identifications, a universal user-product code conforming to a corresponding global code; and
J. creating a database of said universal user-product codes associated with said user.

12. (New) The method of claim 11, further comprising:
K. entering a purchase inquiry for a product represented in said database of universal user-product codes and identifying a country of importation; and
L. correlating to said product a universal user-product code, including selecting said universal user-product code from said database of universal product-codes, as a function of a base HS code representative of said product and said country of importation.

13. (New) A method for generating universal HS based user-product codes from a set of global codes and a set of universal country codes for each of a plurality of countries, each global code comprised of a base HS code and a universal extension representing categories and category values derived from country codes from said plurality of countries having said base HS code in common and each universal country code, for a given country from said countries, conforming to a format of a global code having the same base HS code and representing a combination of categories and category values represented in the country codes for said given country, said method comprising:
A. entering a set of user and product information, including an identification of a user and a set of product identifications associated with said user;
B. generating for each of said product identifications, a universal user-product code conforming to a corresponding global code; and
C. creating a database of said universal user-product codes associated with said user.

14. (New) The method of claim 13, wherein said user and product information is entered via a Web browser interface and over network.

15. (New) The method of claim 13, wherein entering said user and product information includes entering a SKU number and product name.

16. (New) The method of claim 13, wherein entering said product information includes selecting one or more of a product type or name, base HS code, category, or category value from a database.

17. (New) The method of claim 13, wherein entering said user and product information includes entering a start date and an end date that define a period for which use of said product information is valid.

18. (New) The method of claim 13, wherein part B includes validating said user-product code.

19. (New) The method of claim 18, wherein said validating includes:
1) calculating one or more of a tariff, a shipping cost, taxes, and an insurance cost associated with importing said product to a country of importation.

20. (New) The method of claim 18, wherein said validating includes:
1) calculating a total landed cost associated with importing said product to a country of importation, said total landed cost including a tariff, a shipping costs, taxes, and an insurance cost.

21. (New) An HS based global code generation system for products from a plurality of HS based country codes, wherein each country code includes a base HS code and may further include product code extensions, said system comprising:
A. a base HS code selector, configured to select a first base HS code from a plurality of defined first HS codes;
B. a universal extension module, configured to process a plurality of country codes representing products from a plurality of countries having said first base HS code in common, said universal extension module comprising:
1) a country code selector, configured to select for a given country a set of country codes that include said first base HS code;
2) an extractor, configured to extract from extensions of said set of country codes, a set of country specific categories and category values; and
3) an extension integrator, configured to determine if said extracted categories and category values are included in a superset of categories and values related to said first base HS code and, to the extent not included, further configured to integrate said extracted categories and category values into said superset of categories and category values; and
4) a universal extension generator, configured to generate a universal extension for said first base HS code from said superset of categories and category values; and
C. global code generator, configured to combine said first base HS code with a corresponding universal extension to form a global code.

22. (New) The system of claim 21, further comprising a network interface for facilitating entry of one or more of said country codes via a graphical user interface of a network enabled device.

23. (New) The system of claim 21, wherein said base HS codes are represented with 6 digits and said extensions are comprised of categories represented with digit pairs.

24. (New) The system of claim 21, wherein said base HS codes are represented with 6 digits and said extensions are comprised of categories represented with three digits.

25. (New) The system of claim 21, wherein for each base HS code each category represents a product attribute and each category value for a given category represents a different set of attribute values.

26. (New) The system of claim 21, wherein substantially each category includes a category value of “not applicable”.

27. (New) The system of claim 21, wherein one or more of said categories includes a category value representing a plurality of product attribute values.

28. (New) The system of claim 21, further comprising:
D. a universal country code generator, configured to generate, for a given country, a set of universal country codes, each of said universal country codes conforming to the global code for a given base HS code and utilizing category values defined for said given country with respect to said given base HS code.

29. (New) The system of claim 28, further comprising:
E. a universal country code table generator, configured to generate, for a given country, a country code table comprised of said set of universal country codes.

30. (New) The system of claim 21, further comprising:
D. a master universal tariff table generator, configured to generate a master universal tariff table comprising said global codes.

31. (New) The System of claim 21, further comprising:
D. a user interface, configured to facilitate entry of a set of user and product information, including an identification of a user and a set of product identifications associated with said user;
E. a universal user-product code generator, configured to generate, for each of said product identifications, a universal user-product code conforming to a corresponding global code; and
F. a database for storing said universal user-product codes in association with said user.

32. (New) The system of claim 31, further comprising:
G. a data entry interface, configured to facilitate entry of a purchase inquiry for a product represented in said database of universal user-product codes and identification of a country of importation; and
H. a purchase inquiry processor, configured to correlate to said product a universal user-product code, including selection of said universal user-product code from said database of universal product-codes, as a function of a base HS code representative of said product and said country of importation.

33. (New) A universal HS based user-product code generation system, including a set of global code and a set of universal country codes for each of a plurality of countries, each global code comprised of a base HS code and a universal extension representing categories and category values derived from country codes from said plurality of countries having said base HS code in common and each universal country code, for a given country from said countries, conforming to a format of a global code having the same base HS code and representing a combination of categories and category values represented in the country codes for said given country, said system comprising:
A. a user interface, configured to facilitate entry of a set of user and product information, including an identification of a user and a set of product identifications associated with said user;
B. a universal user-product code generator, configured to generate, for each of said product identifications, a universal user-product code conforming to a corresponding global code; and
C. a database for storing said universal user-product codes in association with said user.

34. (New) The system of claim 33, further comprising a network interface for facilitating entry of said user and product information via a said user interface.

35. (New) The system of claim 33, wherein said user and product information includes a SKU number and product name.

36. (New) The system of claim 33, wherein said user interface includes one or more selector mechanisms configured to facilitate entry of said product information by selecting one or more of a product type or name, base HS code, category, or category value from a database.

37. (New) The system of claim 33, wherein said user interface includes at least one mechanism configured to facilitate entry of said user and product information by entering a start date and an end date that define a period for which use of said product information is valid.

38. (New) The system of claim 33, wherein said universal user-product code generator includes a validation mechanism for validating said user-product code.

39. (New) The system of claim 38, wherein said validation mechanism includes:
a calculation mechanism for determining one or more of a tariff a shipping cost, taxes, and an insurance cost associated with importing said product to a country of importation.

40. (New) The method of claim 38, wherein said validation mechanism includes:
a calculation mechanism for determining a total landed cost associated with importing said product to a country of importation, said total landed cost including a tariff, a shipping cost, taxes, and an insurance cost.
